(19) United States
(12) Patent Application Publication
(10) Pub. No.: US 2026/0152420 A1
(43) Pub. Date: Jun. 4, 2026

(54) WATER TREATMENT APPARATUS

(71) Applicant: SAMSUNG ELECTRONICS CO., LTD., Suwon-si (KR)

(72) Inventors: Wonji JUNG, Suwon-si (KR); Jeeyeon KIM, Suwon-si (KR); Changhoon OH, Suwon-si (KR); Youngkyu CHO, Suwon-si (KR)

(73) Assignee: SAMSUNG ELECTRONICS CO., LTD., Suwon-si (KR)

(21) Appl. No.: 19/371,552

(22) Filed: Oct. 28, 2025

Related U.S. Application Data
(63) Continuation of application No. PCT/KR2025/095590, filed on Sep. 17, 2025.

(30) Foreign Application Priority Data
Dec. 2, 2024 (KR) 10-2024-0176920

(51) Int. Cl. C02F 1/469; B01D 61/42

(52) U.S. Cl. CPC C02F 1/4691; B01D 61/428; B01D 2313/10; B01D 2313/19; B01D 2313/345; C02F 2209/40

(57) ABSTRACT

A water treatment apparatus includes a housing including a device inlet and a device outlet, a deionization device including a plurality of electrodes and a plurality of deionization channels configured to be formed between the plurality of electrodes to allow a fluid introduced through the device inlet to pass the plurality of deionization channels, and a flow regulator configured to, based on a flow rate of the fluid introduced through the device inlet, regulate a number of deionization channels into which the fluid flows among the plurality of deionization channels.

### CROSS-REFERENCE TO RELATED APPLICATIONS

This application is a continuation of International Application No. PCT/KR2025/095590, filed on Sep. 17, 2025, which is based on and claims priority to Korean Patent Application No. 10-2024-0176920, filed on Dec. 2, 2024, in the Korean Intellectual Property Office, the disclosures of which are incorporated by reference herein in their entireties.

### BACKGROUND

### 1. Field

The present disclosure relates to a water treatment apparatus using a capacitive deionization technology.

### 2. Description of Related Art

A deionization technology is widely demanded across various industries, such as removing hardness components such as calcium and magnesium from water in areas with high hardness of water to use the water as drinking water or boiler water or as cooling water for power plants or factories.

A capacitive deionization (CDI) technology is an example of the deionization technology, which removes ions by electrochemically adsorbing the ions onto electrodes with high specific surface areas.

A capacitive deionization device includes channels, electrodes with high specific surface areas positioned on both sides of the channels to adsorb ions of fluids flowing through the channels, and ion exchange membranes for selectively moving specific ions. The capacitive deionization device is configured to move ions by electric fields generated inside the channels in directions perpendicular to the directions in which the fluids flow.

The capacitive deionization device is included in appliances requiring relatively small flow rates, such as water purifiers or humidifiers, or in appliances requiring relatively large flow rates, such as dishwashers or washing machines.

### SUMMARY

Provided a water treatment apparatus which may have improved efficiency.

Further, provided is a water treatment apparatus which may have improved convenience of use.

Further, provided is a water treatment apparatus which may have improved usability.

The technical aspects intended to be achieved by the present document is not limited to the above-mentioned technical aspects, and other technical aspects not mentioned will be clearly understood by one of ordinary skill in the technical art to which the disclosure belongs from the following description.

According to an aspect of the disclosure, a water treatment apparatus includes: a housing including a device inlet and a device outlet; a deionization device including a plurality of electrodes and a plurality of deionization channels configured to be formed between the plurality of electrodes to pass a fluid introduced through the device inlet to the plurality of deionization channels; and a flow regulator configured to, based on a flow rate of the fluid introduced through the device inlet, regulate a number of deionization channels into which the fluid flows among the plurality of deionization channels.

According to an aspect of the disclosure, a water treatment apparatus includes: a housing including a device inlet and a device outlet; a first electrode; a second electrode; an intermediate electrode provided between the first electrode and the second electrode; a first deionization channel formed between the first electrode and the intermediate electrode; a second deionization channel formed between the second electrode and the intermediate electrode; and a flow regulator configured to open and close the first deionization channel and the second deionization channel based on a flow rate of a fluid flowing into the housing.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 is a conceptual diagram of a water treatment apparatus according to an embodiment of the disclosure;

FIG. 2 is a conceptual diagram of a deionization device in a water treatment apparatus according to an embodiment of the disclosure;

FIG. 3 is a control block diagram of a water treatment apparatus according to an embodiment of the disclosure;

FIG. 4 is a conceptual diagram for describing movements of ions that occur while a water treatment apparatus according to an embodiment of the disclosure performs a deionization operation;

FIG. 5 is a conceptual diagram of a deionization device and a flow regulator in a water treatment apparatus according to an embodiment of the disclosure;

FIG. 6 is a conceptual diagram of a deionization device and a flow regulator while a first deionization channel of a water treatment apparatus according to an embodiment of the disclosure opens;

FIG. 7 is a conceptual diagram of a deionization device and a flow regulator while a first deionization channel and a second deionization channel of a water treatment apparatus according to an embodiment of the disclosure open;

FIG. 8 is a conceptual diagram of a deionization device and a flow regulator while a first deionization channel, a second deionization channel, and a third deionization channel of a water treatment apparatus according to an embodiment of the disclosure open;

FIG. 9 is a conceptual diagram of a deionization device and a flow regulator while a first deionization channel of a water treatment apparatus according to an embodiment of the disclosure partially opens;

FIG. 10 is an enlarged view of a portion of a water treatment apparatus according to an embodiment of the disclosure where a state display is positioned;

FIG. 11 is a conceptual diagram of a deionization device and a flow regulator while all of a first deionization channel, a second deionization channel, and a third deionization channel of a water treatment apparatus according to an embodiment of the disclosure are closed;

FIG. 12 is a conceptual diagram of a deionization device and a flow regulator while a first deionization channel of a water treatment apparatus according to an embodiment of the disclosure opens;

FIG. 13 is a conceptual diagram of a deionization device and a flow regulator while a first deionization channel and a second deionization channel of a water treatment apparatus according to an embodiment of the disclosure open;

FIG. 14 is a conceptual diagram of a deionization device and a flow regulator while all of a first deionization channel, a second deionization channel, and a third deionization channel of a water treatment apparatus according to an embodiment of the disclosure open;

FIG. 15 shows a washing machine to which a water treatment apparatus according to an embodiment of the disclosure is connected;

FIG. 16 shows a cross section of a washing machine to which a water treatment apparatus according to an embodiment of the disclosure is connected;

FIG. 17 shows a refrigerator to which a water treatment apparatus according to an embodiment of the disclosure is connected;

FIG. 18 shows a state in which doors of a refrigerator to which a water treatment apparatus according to an embodiment of the disclosure is connected open;

FIG. 19 shows a cross section of a refrigerator to which a water treatment apparatus according to an embodiment of the disclosure is applied;

FIG. 20 shows a dishwasher to which a water treatment apparatus according to an embodiment of the disclosure is connected;

FIG. 21 shows a cross section of a dishwasher to which a water treatment apparatus according to an embodiment of the disclosure is applied; and

FIG. 22 shows a water purifier to which a water treatment apparatus according to an embodiment of the disclosure is applied.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1^{st}”, “2^{nd}”, or “first” or “second” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that any of the above components can be connected to the other components directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

A water treatment apparatus according to various embodiments may purify polluted water to make the water clean. The water treatment apparatus is used in sewage treatment facilities, industrial processes, water supply systems in homes or offices, etc. and play an important role in environment protection and human health. Water purified into a clean state by the water treatment apparatus may be discharged back into nature, used for cleaning purposes, used as drinking water, or reused in industrial processes, etc.

According to various embodiments, the water treatment apparatus may include not only a household water treatment apparatus such as a water purifier or a water softener, but also an industrial water treatment apparatus.

The water treatment apparatus may purify polluted water through various methods, such as a biological treatment method, a chemical treatment method, and a physical treatment method.

The water treatment apparatus according to an embodiment may purify polluted water through a capacitive deionization (CDI) method.

The capacitive deionization method may include a method of removing ions from polluted water by utilizing a principle that ions are adsorbed onto and desorbed from surfaces of electrodes by an electric force generated between the electrodes. In the present specification, removing ions from polluted water may include removing ionic materials from polluted water.

The water treatment apparatus may include various components, such as a plurality of pipes through which water flows, a plurality of valves for controlling flow of water, and a capacitive deionization module for purifying water using a capacitive deionization method.

The capacitive deionization module may include a housing, and electrodes and ion exchange membranes provided in the housing. Depending on a voltage supplied to the electrodes, ions contained in water flowing into the housing may be adsorbed onto or desorbed from the electrodes.

According to various embodiments, the water treatment apparatus may further include various components, such as a pretreatment filter for pretreating raw water and supplying the water to the capacitive deionization module, and/or a post-treatment filter for filtering water purified by the capacitive deionization module once again.

Also, in the disclosure, a porous electrode may be a porous material layer formed on a current collector of an electrode for a water treatment apparatus, and the porous electrode may be replaced with terms such as “active material layer,” “electrode active material layer,” “porous material layer,” “porous active material layer,” and “porous electrode active material layer.”

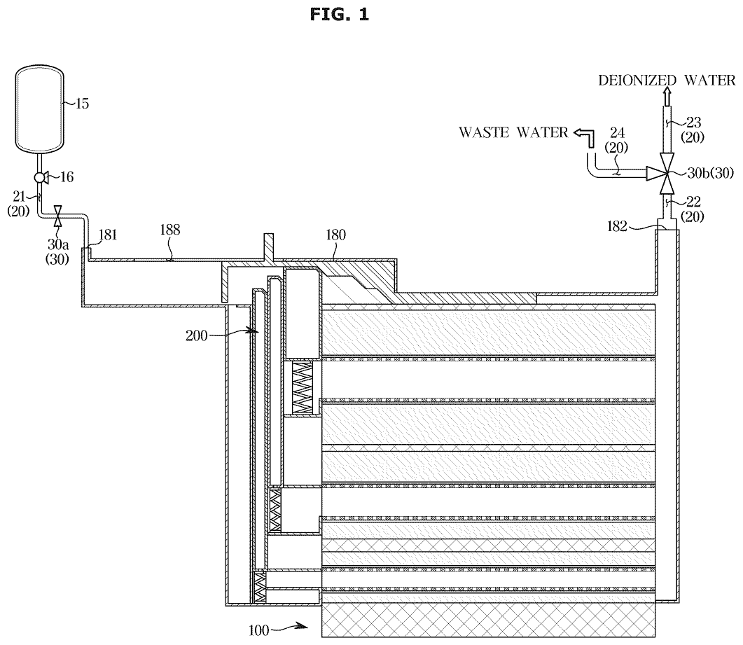

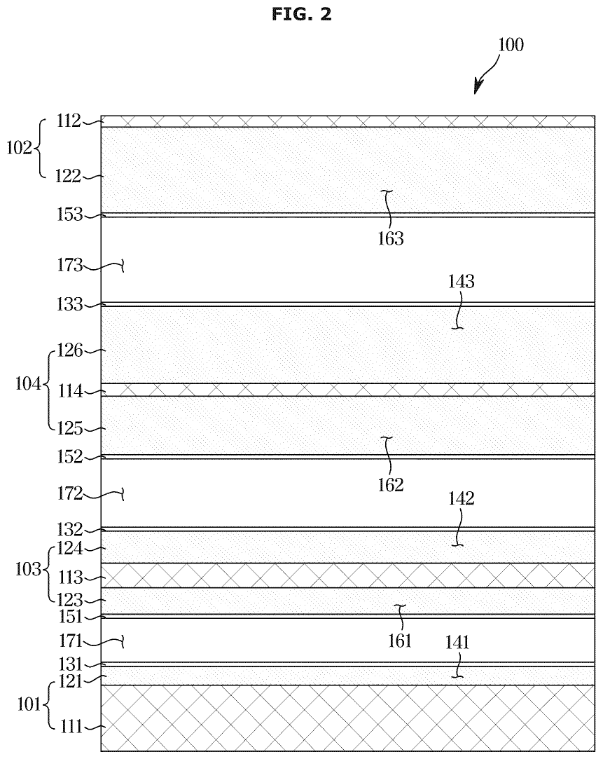

FIG. 1 is a conceptual diagram of a water treatment apparatus according to an embodiment of the disclosure. FIG. 2 is a conceptual diagram of a deionization device in a water treatment apparatus according to an embodiment of the disclosure.

Referring to FIG. 1 and FIG. 2, a water treatment apparatus 1 according to an embodiment may include a deionization device 100. For example, the deionization device 100 may include a plurality of electrodes, such as a first electrode 101, a second electrode 102, a third electrode 103, and a fourth electrode 104, and a plurality of deionization channels, such as a first deionization channel 171, a second deionization channel 172, and a third deionization channel 173, that may be formed between the plurality of electrodes, such as the first electrode 101, the second electrode 102, the third electrode 103, and the fourth electrode 104.

The deionization device 100 may include the first electrode 101, the second electrode 102, and an intermediate electrode, such as any one or more of the third electrode 103 and the fourth electrode 104. The intermediate electrode, such as any one or more of the third electrode 103 and the fourth electrode 104, may be located between the first electrode 101 and the second electrode 102.

For example, the intermediate electrode may include the third electrode 103 and the fourth electrode 104. In FIG. 1, the intermediate electrode is shown as including the third electrode 103 and the fourth electrode 104, but the intermediate electrode may include only one electrode or may include three or more electrodes.

The first electrode 101 may face the third electrode 103. The first electrode 101 and the third electrode 103 may form an electric field. The third electrode 103 may face the fourth electrode 104. The third electrode 103 and the fourth electrode 104 may form an electric field. The fourth electrode 104 may face the second electrode 102. The fourth electrode 104 and the second electrode 102 may form an electric field.

The first electrode 101 may include a first current collector 111 and a first porous electrode 121. The first electrode 101 may be a positive electrode (anode) or a negative electrode (cathode).

In an embodiment, the first current collector 111 may include an electrode plate electrically connected to the first porous electrode 121. The electrode plate may include a metal plate and/or a non-metal plate.

The first current collector 111 may include a conductor. For example, the first current collector 111 may include graphite.

For example, the first current collector 111 may include a compressible material. The first current collector 111 may include a deformable material. The first current collector 111 may include a deformable and restorable material.

For example, two-dimensional graphene may be functionalized with graphene oxide by a hydroxyl group or a carboxyl group. In this case, the graphene oxide may be dispersed in water to form an aqueous solution. After the graphene oxide aqueous solution is put into a container, a high temperature of 180° C. may be applied to produce a foam composed of reduced graphene oxide. The produced foam may be composed of reduced graphene oxide, have conductivity, and be deformable (for example, compressible) and restorable by an external force.

The first porous electrode 121 may include a solid electrode including a void space. The first porous electrode 121 may include a material that is easy to adsorb ions. For example, the first porous electrode 121 may include a carbon porous electrode.

For example, the first porous electrode 121 may include a carbon-based active material including at least one selected from among activated carbon, graphene, carbon nanotubes, carbon fibers, or carbon aerogel. The carbon-based active material may be manufactured in powder form and used.

The second electrode 102 may include a second current collector 112 and a second porous electrode 122. The second electrode 102 may be a positive electrode (anode) or a negative electrode (cathode).

In an embodiment, the second current collector 112 may include an electrode plate electrically connected to the second porous electrode 122. The electrode plate may include a metal plate and/or a non-metal plate.

The second current collector 112 may include a conductor. The second current collector 112 may include the same composition as the first current collector 111. For example, the second current collector 112 may include graphite. As an example, the second current collector 112 may include a compressible material. The second current collector 112 may include a deformable material. The second current collector 112 may include a deformable and restorable material. In an embodiment, the second current collector 112 may include a material that is difficult from that of the first current collector 111.

The second porous electrode 122 may include a solid electrode including a void space. The second porous electrode 122 may include the same composition as the first porous electrode 121. The second porous electrode 122 may include a material that is easy to adsorb ions. For example, the second porous electrode 122 may include a carbon porous electrode. In an embodiment, the second porous electrode 122 may include a material that is different from that of the first porous electrode 121.

For example, the second porous electrode 122 may include a carbon-based active material including at least one selected from among activated carbon, graphene, carbon nanotubes, carbon fibers, or carbon aerogel. The carbon-based active material may be manufactured in powder form and used.

The third electrode 103 may include a third current collector 113, a third porous electrode 123, and a fourth porous electrode 124. A portion of the third electrode 103 may be a positive electrode (anode) or a negative electrode (cathode), and correspondingly, the remaining portion may be a negative electrode (cathode) or a positive electrode (anode).

The third porous electrode 123 may be positioned on one side of the third current collector 113, and the fourth porous electrode 124 may be positioned on another side of the third current collector 113 which is opposite to the one side of the third current collector 113. For example, the third porous electrode 123 may be positioned on one side of the third current collector 113 facing the first electrode 101, and the fourth porous electrode 124 may be positioned on one side of the third current collector 113 facing the fourth electrode 104.

In an embodiment, the third current collector 113 may include an electrode plate electrically connected to the third porous electrode 123 and the fourth porous electrode 124. The electrode plate may include a metal plate and/or a non-metal plate.

The third current collector 113 may include a conductor. The third current collector 113 may include the same composition as the first current collector 111 and/or the second current collector 112. For example, the third current collector 113 may include graphite. As an example, the third current collector 113 may include a compressible material. The third current collector 113 may include a deformable material. The third current collector 113 may include a deformable and restorable material. In an embodiment, the third current collector 113 may include a material that is different from that of the first current collector 111 and/or the second current collector 112.

The third porous electrode 123 may include a solid electrode including a void space. The third porous electrode 123 may include the same composition as the first porous electrode 121 and/or the second porous electrode 122. The third porous electrode 123 may include a material that is easy to adsorb ions. For example, the third porous electrode 123 may include a carbon porous electrode. In an embodiment, the third porous electrode 123 may include a material that is different from that of the first porous electrode 121 and/or the second porous electrode 122.

For example, the third porous electrode 123 may include a carbon-based active material including at least one selected from among activated carbon, graphene, carbon nanotubes, carbon fibers, or carbon aerogel. The carbon-based active material may be manufactured in a powder form and used.

The fourth porous electrode 124 may include a solid electrode including a void space. The fourth porous electrode 124 may include the same composition as the first porous electrode 121, the second porous electrode 122, and/or the third porous electrode 123. The fourth porous electrode 124 may include a material that is easy to adsorb ions. For example, the fourth porous electrode 124 may include a carbon porous electrode. In an embodiment, the fourth porous electrode 124 may include a material that is different from that of the first porous electrode 121, the second porous electrode 122, and/or the third porous electrode 123.

For example, the fourth porous electrode 124 may include a carbon-based active material including at least one selected from among activated carbon, graphene, carbon nanotubes, carbon fibers, or carbon aerogel. The carbon-based active material may be manufactured in powder form and used.

The fourth electrode 104 may include a fourth current collector 114, a fifth porous electrode 125, and a sixth porous electrode 126. A portion of the fourth electrode 104 may be a positive electrode (anode) or a negative electrode (cathode), and correspondingly, the remaining portion may be a negative electrode (cathode) or a positive electrode (anode).

The fifth porous electrode 125 may be positioned on one side of the fourth current collector 114, and the sixth porous electrode 126 may be positioned on another side of the fourth current collector 114 which is opposite to the one side of the fourth current collector 114. For example, the fifth porous electrode 125 may be positioned on one side of the fourth current collector 114 facing the third electrode 103, and the sixth porous electrode 126 may be positioned on one side of the fourth current collector 114 facing the second electrode 102.

In an embodiment, the fourth current collector 114 may include an electrode plate electrically connected to the fifth porous electrode 125 and the sixth porous electrode 126. The electrode plate may include a metal plate and/or a non-metal plate.

The fourth current collector 114 may include a conductor. The fourth current collector 114 may include the same composition as the first current collector 111, the second current collector 112, and/or the third current collector 113. For example, the fourth current collector 114 may include graphite. As an example, the fourth current collector 114 may include a compressible material. The fourth current collector 114 may include a deformable material. The fourth current collector 114 may include a deformable and restorable material. In an embodiment, the fourth current collector 114 may include a material that is different from that of the first current collector 111, the second current collector 112, and/or the third current collector 113.

The fifth porous electrode 125 may include a solid electrode including a void space. The fifth porous electrode 125 may include the same composition as the first porous electrode 121, the second porous electrode 122, the third porous electrode 123, and/or the fourth porous electrode 124. The fifth porous electrode 125 may include a material that is easy to adsorb ions. For example, the fifth porous electrode 125 may include a carbon porous electrode. In an embodiment, the fifth porous electrode 125 may include a material that is different from that of the first porous electrode 121, the second porous electrode 122, the third porous electrode 123, and/or the fourth porous electrode 124.

For example, the fifth porous electrode 125 may include a carbon-based active material including at least one selected from among activated carbon, graphene, carbon nanotubes, carbon fibers, or carbon aerogel. The carbon-based active material may be manufactured in powder form and used.

The sixth porous electrode 126 may include a solid electrode including a void space. The sixth porous electrode 126 may include the same composition as the first porous electrode 121, the second porous electrode 122, the third porous electrode 123, the fourth porous electrode 124, and/or the fifth porous electrode 125. The sixth porous electrode 126 may include a material that is easy to adsorb ions. For example, the sixth porous electrode 126 may include a carbon porous electrode. In an embodiment, the sixth porous electrode 126 may include a material that is different from that of the first porous electrode 121, the second porous electrode 122, the third porous electrode 123, the fourth porous electrode 124, and/or the fifth porous electrode 125.

For example, the sixth porous electrode 126 may include a carbon-based active material including at least one selected from among activated carbon, graphene, carbon nanotubes, carbon fibers, or carbon aerogel. The carbon-based active material may be manufactured in powder form and used.

For example, the first porous electrode 121, the second porous electrode 122, the third porous electrode 123, the fourth porous electrode 124, the fifth porous electrode 125, and the sixth porous electrode 126 may have different ion storage capacities. For example, the first porous electrode 121, the second porous electrode 122, the third porous electrode 123, the fourth porous electrode 124, the fifth porous electrode 125, and the sixth porous electrode 126 may have different sizes.

For example, the second porous electrode 122 may have the same size as the sixth porous electrode 126 or a larger size than the sixth porous electrode 126. For example, the sixth porous electrode 126 may have the same size as the fifth porous electrode 125 or a larger size than the fifth porous electrode 125. For example, the fifth porous electrode 125 may have the same size as the fourth porous electrode 124 or a larger size than the fourth porous electrode 124. For example, the fourth porous electrode 124 may have the same size as the third porous electrode 123 or a larger size than the third porous electrode 123. For example, the third porous electrode 123 may have the same size as the first porous electrode 121 or a larger size than the first porous electrode 121.

For example, the porous electrodes, such as the first porous electrode 121, the second porous electrode 122, the third porous electrode 123, the fourth porous electrode 124, the fifth porous electrode 125, and the sixth porous electrode 126, may be prepared with various thicknesses by controlling a ratio of materials, controlling viscosity of slurry for coating, controlling a width of a coating blade, or controlling drying conditions.

The deionization device 100 may include a first anion exchange membrane 131. The first anion exchange membrane 131 may include a membrane that transmits only anions among cations and anions. Because the first anion exchange membrane 131 has positive charges, the first anion exchange membrane 131 may repel cations not to transmit the cations and may transmit only anions.

For example, the first anion exchange membrane 131 may be positioned adjacent to the first electrode 101. The first anion exchange membrane 131 may be positioned on another side of the first porous electrode 121 which is opposite to one side of the first porous electrode 121 on which the first current collector 111 is positioned.

The deionization device 100 may include a first anion channel 141 formed by the first current collector 111 and the first anion exchange membrane 131. The first anion channel 141 may include a space between the first current collector 111 and the first anion exchange membrane 131. The first porous electrode 121 may be provided in the first anion channel 141.

The deionization device 100 may include a second anion exchange membrane 132. The second anion exchange membrane 132 may include a membrane that transmits only anions among cations and anions. Because the second anion exchange membrane 132 has positive charges, the second anion exchange membrane 132 may repel cations not to transmit the cations and may transmit only anions.

For example, the second anion exchange membrane 132 may be positioned adjacent to the third electrode 103. The second anion exchange membrane 132 may be positioned on another side of the fourth porous electrode 124 which is opposite to one side of the fourth porous electrode 124 on which the third current collector 113 is positioned.

The deionization device 100 may include a second anion channel 142 formed by the third current collector 113 and the second anion exchange membrane 132. The second anion channel 142 may include a space between the third current collector 113 and the second anion exchange membrane 132. The fourth porous electrode 124 may be provided in the second anion channel 142.

The deionization device 100 may include a third anion exchange membrane 133. The third anion exchange membrane 133 may include a membrane that transmits only anions among cations and anions. Because the third anion exchange membrane 133 has positive charges, the third anion exchange membrane 133 may repel cations not to transmit the cations and may transmit only anions.

For example, the third anion exchange membrane 133 may be positioned adjacent to the fourth electrode 104. The third anion exchange membrane 133 may be positioned on another side of the sixth porous electrode 126 which is opposite to one side of the sixth porous electrode 126 on which the fourth current collector 114 is positioned.

The deionization device 100 may include a third anion channel 143 formed by the fourth current collector 114 and the third anion exchange membrane 133. The third anion channel 143 may include a space between the fourth current collector 114 and the third anion exchange membrane 133. The sixth porous electrode 126 may be provided in the third anion channel 143.

The deionization device 100 may include a first cation exchange membrane 151. The first cation exchange membrane 151 may include a membrane that transmits only cations among cations and anions. Because the first cation exchange membrane 151 has negative charges, the first cation exchange membrane 151 may repel anions not to transmit the anions and may transmit only cations.

For example, the first cation exchange membrane 151 may be positioned adjacent to the third electrode 103. The first cation exchange membrane 151 may be positioned on another side of the third porous electrode 123 which is opposite to one side of the third porous electrode 123 on which the third current collector 113 is positioned.

The deionization device 100 may include a first cation channel 161 formed by the third current collector 113 and the first cation exchange membrane 151. The first anion channel 161 may include a space between the third current collector 113 and the first cation exchange membrane 151. The third porous electrode 123 may be provided in the first cation channel 161.

The deionization device 100 may include a second cation exchange membrane 152. The second cation exchange membrane 152 may include a membrane that transmits only cations among cations and anions. Because the second cation exchange membrane 152 has negative charges, the second cation exchange membrane 152 may repel anions not to transmit the anions and may transmit only cations.

For example, the second cation exchange membrane 152 may be positioned adjacent to the fourth electrode 104. The second cation exchange membrane 152 may be positioned on another side of the fifth porous electrode 125 which is opposite to one side of the fifth porous electrode 125 on which the fourth current collector 114 is positioned.

The deionization device 100 may include a second cation channel 162 formed by the fourth current collector 114 and the second cation exchange membrane 152. The second cation channel 162 may include a space between the fourth current collector 114 and the second cation exchange membrane 152. The fifth porous electrode 125 may be provided in the second cation channel 162.

The deionization device 100 may include a third cation exchange membrane 153. The third cation exchange membrane 153 may include a membrane that transmits only cations among cations and anions. Because the third cation exchange membrane 153 has negative charges, the third cation exchange membrane 153 may repel anions not to transmit the anions and may transmit only cations.

For example, the third cation exchange membrane 153 may be positioned adjacent to the second electrode 102. The third cation exchange membrane 153 may be positioned on another side of the second porous electrode 122 which is opposite to one side of the second porous electrode 122 on which the second current collector 112 is positioned.

The deionization device 100 may include a third cation channel 163 formed by the second current collector 112 and the third cation exchange membrane 153. The third cation channel 163 may include a space between the second current collector 112 and the third cation exchange membrane 153. The second porous electrode 122 may be provided in the third cation channel 163.

The first anion exchange membrane 131, the second anion exchange membrane 132, the third anion exchange membrane 133, the first cation exchange membrane 151, the second cation exchange membrane 152, and/or the third cation exchange membrane 153 may include a membrane through which a fluid passes. For example, the first anion exchange membrane 131, the second anion exchange membrane 132, the third anion exchange membrane 133, the first cation exchange membrane 151, the second cation exchange membrane 152, and/or the third cation exchange membrane 153 may include a synthetic resin membrane.

The deionization device 100 may include a first deionization channel 171. The first deionization channel 171 may be formed by the first anion exchange membrane 131 and the first cation exchange membrane 151. The first deionization channel 171 may include a space between the first anion exchange membrane 131 and the first cation exchange membrane 151. The first electrode 101 may be positioned to one side of the first deionization channel 171, and the third electrode 103 may be positioned to another side of the first deionization channel 171 which is opposite to the one side of the first deionization channel 171.

The deionization device 100 may include a second deionization channel 172. The second deionization channel 172 may be formed by the second anion exchange membrane 132 and the second cation exchange membrane 152. The second deionization channel 172 may include a space between the second anion exchange membrane 132 and the second cation exchange membrane 152. The third electrode 103 may be positioned to one side of the second deionization channel 172, and the fourth electrode 104 may be positioned to another side of the second deionization channel 172 which is opposite to the one side of the second deionization channel 172.

The deionization device 100 may include a third deionization channel 173. The third deionization channel 173 may be formed by the third anion exchange membrane 133 and the third cation exchange membrane 153. The third deionization channel 173 may include a space between the third anion exchange membrane 133 and the third cation exchange membrane 153. The fourth electrode 104 may be positioned to one side of the third deionization channel 173, and the second electrode 102 may be positioned to another side of the third deionization channel 173 which is opposite to the one side of the third deionization channel 173.

For example, the first deionization channel 171 may be smaller than the second deionization channel 172. A gap between the first electrode 101 and the third electrode 103, which forms the first deionization channel 171, may be smaller than a gap between the third electrode 103 and the fourth electrode 104, which forms the second deionization channel 172.

First deionization performance in which ions are removed from a fluid passing through the first deionization channel 171 may be equal to or lower than second deionization performance in which ions are removed from a fluid passing through the second deionization channel 172. Because the first deionization channel 171 has a smaller gap than the second deionization channel 172, the first deionization channel 171 may have higher deionization performance. However, because the ion storage capacities of the first electrode 101 and the third electrode 103 forming the first deionization channel 171 are smaller than the ion storage capacities of the third electrode 103 and the fourth electrode 104 forming the second deionization channel 172, the deionization performance of the first deionization channel 171 may be equal to or lower than that of the second deionization channel 172.

For example, the second deionization channel 172 may be smaller than the third deionization channel 173. The gap between the third electrode 103 and the fourth electrode 104, which forms the second deionization channel 172, may be smaller than a gap between the fourth electrode 104 and the second electrode 102, which forms the third deionization channel 173.

The second deionization performance in which ions are removed from a fluid passing through the second deionization channel 172 may be equal to or lower than third deionization performance in which ions are removed from a fluid passing through the third deionization channel 173. Because the second deionization channel 172 has a smaller gap than the third deionization channel 173, the second deionization channel 172 may have higher deionization performance. However, because the ion storage capacities of the third electrode 103 and the fourth electrode 104 forming the second deionization channel 172 are smaller than the ion storage capacities of the fourth electrode 104 and the second electrode 102 forming the third deionization channel 173, the deionization performance of the second deionization channel 172 may be equal to or lower than that of the third deionization channel 173.

The first anion channel 141, the second anion channel 142, the third anion channel 143, the first cation channel 161, the second cation channel 162, the third cation channel 163, the first deionization channel 171, the second deionization channel 172, and/or the third deionization channel 173 may be replaced with terms such as compartments, spaces, rooms, or chambers, in that the first anion channel 141, the second anion channel 142, the third anion channel 143, the first cation channel 161, the second cation channel 162, the third cation channel 163, the first deionization channel 171, the second deionization channel 172, and/or the third deionization channel 173 are separated from each other by the ion exchange membranes, such as the first anion exchange membrane 131, the second anion exchange membrane 132, the third anion exchange membrane 133, the first cation exchange membrane 151, the second cation exchange membrane 152, and the third cation exchange membrane 153.

The first anion channel 141, the first cation channel 161, and the first deionization channel 171 may be fluidically connected to each other. For example, a fluid in the first deionization channel 171 may move to the first anion channel 141 and/or the first cation channel 161, and conversely, a fluid in the first anion channel 141 and/or the first cation channel 161 may move to the first deionization channel 171.

The second anion channel 142, the second cation channel 162, and the second deionization channel 172 may be fluidically connected to each other. For example, a fluid in the second deionization channel 172 may move to the second anion channel 142 and/or the second cation channel 162, and conversely, a fluid in the second anion channel 142 and/or the second cation channel 162 may move to the second deionization channel 172.

The third anion channel 143, the third cation channel 163, and the third deionization channel 173 may be fluidically connected to each other. For example, a fluid in the third deionization channel 173 may move to the third anion channel 143 and/or the third cation channel 163, and conversely, a fluid in the third anion channel 143 and/or the third cation channel 163 may move to the third deionization channel 173.

While a positive voltage is applied to the first current collector 111, the first electrode 101 may become a positive electrode (anode), and while a negative voltage is applied to the second current collector 112, the second electrode 102 may become a negative electrode (cathode).

Applying a positive voltage to the first current collector 111 and applying a negative voltage to the second current collector 112 may include causing a potential of the first current collector 111 to be higher than that of the second current collector 112.

Applying a positive voltage to the first current collector 111 may include applying a negative voltage to the second current collector 112.

Applying a positive voltage to the first current collector 111 and applying a negative voltage to the second current collector 112 may include applying a positive voltage between the first current collector 111 and the second current collector 112.

Applying a positive voltage between the first current collector 111 and the second current collector 112 may include causing a potential of the first current collector 111 to be higher than that of the second current collector 112.

As a positive voltage is applied to the first current collector 111 and a negative voltage is applied to the second current collector 112, one side of the third current collector 113 may be charged with a negative voltage and the opposite side may be charged with a positive voltage. For example, a side of the third electrode 103 facing the first electrode 101 may become a cathode, and another side facing the fourth electrode 104 may become an anode.

As a positive voltage is applied to the first current collector 111 and a negative voltage is applied to the second current collector 112, one side of the fourth current collector 114 may be charged with a negative voltage and the opposite side may be charged with a positive voltage. For example, a side of the fourth electrode 104 facing the third electrode 103 may become a cathode, and another side facing the second electrode 102 may become an anode.

While a positive voltage is applied to the first current collector 111 and a first side of the third current collector 113 is charged with a negative potential, cations in the first deionization channel 171 may move to the first cation channel 161, and anions in the first deionization channel 171 may move to the first anion channel 141.

The anions moved to the first anion channel 141 while a positive voltage is applied to the first current collector 111 may be adsorbed onto the first porous electrode 121, and the cations moved to the first cation channel 161 while the first side of the third current collector 113 is charged with a negative potential may be adsorbed onto the third porous electrode 123.

While a second side of the third current collector 113 is charged with a positive potential and a first side of the fourth current collector 114 is charged with a negative potential, cations in the second deionization channel 172 may move to the second cation channel 162 and anions in the second deionization channel 172 may move to the second anion channel 142.

The anions moved to the second anion channel 142 while the second side of the third current collector 113 is charged with a positive potential may be adsorbed onto the fourth porous electrode 124, and the cations moved to the second cation channel 162 while the first side of the fourth current collector 114 is charged with a negative potential may be adsorbed onto the fifth porous electrode 125.

While a second side of the fourth current collector 114 is charged with a positive potential and a negative voltage is applied to the second current collector 112, cations in the third deionization channel 173 may move to the third cation channel 163 and anions in the third deionization channel 173 may move to the third anion channel 143.

The anions moved to the third anion channel 143 while the second side of the fourth current collector 114 is charged with a positive potential may be adsorbed onto the sixth porous electrode 126, and the cations moved to the third cation channel 163 while a negative voltage is applied to the second current collector 112 may be adsorbed onto the second porous electrode 122.

While a negative voltage is applied to the first current collector 111, the first electrode 101 may become a negative electrode (cathode), and while a positive voltage is applied to the second current collector 112, the second electrode 102 may become a positive electrode (anode).

Applying a negative voltage to the first current collector 111 and applying a positive voltage to the second current collector 112 may include causing a potential of the first current collector 111 to be lower than that of the second current collector 112.

Applying a negative voltage to the first current collector 111 may include applying a positive voltage to the second current collector 112.

Applying a negative voltage to the first current collector 111 and applying a positive voltage to the second current collector 112 may include applying a negative voltage between the first current collector 111 and the second current collector 112.

Applying a negative voltage between the first current collector 111 and the second current collector 112 may include causing a potential of the first current collector 111 to be lower than that of the second current collector 112.

As a negative voltage is applied to the first current collector 111 and a positive voltage is applied to the second current collector 112, one side of the third current collector 113 may be charged with a positive voltage, and the opposite side may be charged with a negative voltage. For example, a side of the third electrode 103 facing the first electrode 101 may become an anode and another side facing the fourth electrode 104 may become a cathode.

As a negative voltage is applied to the first current collector 111 and a positive voltage is applied to the second current collector 112, one side of the fourth current collector 114 may be charged with a positive voltage, and the opposite side may be charged with a negative voltage. For example, a side of the fourth electrode 104 facing the third electrode 103 may become an anode and another side facing the second electrode 102 may become a cathode.

While a negative voltage is applied to the first current collector 111 and the first side of the third current collector 113 is charged with a positive potential, cations in the first cation channel 161 may move to the first deionization channel 171, and anions in the first anion channel 141 may move to the first deionization channel 171.

While a negative voltage is applied to the first current collector 111, anions adsorbed onto the first porous electrode 121 may be desorbed from the first porous electrode 121, and while the first side of the third current collector 113 is charged with a positive potential, cations adsorbed onto the third porous electrode 123 may be desorbed from the third porous electrode 123.

While the second side of the third current collector 113 is charged with a negative potential and the first side of the fourth current collector 114 is charged with a positive potential, cations in the second cation channel 162 may move to the second deionization channel 172, and anions in the second anion channel 142 may move to the second deionization channel 172.

While the second side of the third current collector 113 is charged with a negative potential, anions adsorbed onto the fourth porous electrode 124 may be desorbed from the fourth porous electrode 124, and while the first side of the fourth current collector 114 is charged with a positive potential, cations adsorbed onto the fifth porous electrode 125 may be desorbed from the fifth porous electrode 125.

While the second side of the fourth current collector 114 is charged with a negative potential and a negative voltage is applied to the second current collector 112, cations in the third cation channel 163 may move to the third deionization channel 173 and anions in the third anion channel 143 may move to the third deionization channel 173.

While the second side of the fourth current collector 114 is charged with a negative potential, anions adsorbed onto the sixth porous electrode 126 may be desorbed from the sixth porous electrode 126, and while a negative voltage is applied to the second current collector 112, cations adsorbed onto the second porous electrode 122 may be desorbed from the second porous electrode 122.

While a voltage is applied to the deionization device 100, the water treatment apparatus 1 according to an embodiment of the disclosure may efficiently remove divalent cations contained in raw water through the first electrode 101, the second electrode 102, the third electrode 103, and/or the fourth electrode 104, thereby softening the water.

In an embodiment, the deionization device 100 may include a device inlet 181 through which a fluid is received, and a device outlet 182 through which a fluid is discharged. A fluid flowed into the deionization device 100 through the device inlet 181 may pass through the first deionization channel 171, the second deionization channel 172, and/or the third deionization channel 173. The fluid passed through the first deionization channel 171, the second deionization channel 172, and/or the third deionization channel 173 may be discharged to outside of the deionization device 100 through the device outlet 182.

The water treatment apparatus 1 according to an embodiment may include a housing 180 having the device inlet 181 through which water is received and the device outlet 182 through which deionized water resulting from removing hardness components from the received water or wastewater with hardness components dissolved in the received water is discharged.

In an embodiment, the housing 180 may include the device inlet 181 through which water is flowed into the first deionization channel 171, the second deionization channel 172, and/or the third deionization channel 173, and the device outlet 182 through which deionized water or wastewater in the first deionization channel 171, the second deionization channel 172, and/or the third deionization channel 173 is discharged.

Water may flow from the outside of the deionization device 100 into the first deionization channel 171, the second deionization channel 172, and/or the third deionization channel 173 through the device inlet 181. Water in the first deionization channel 171, the second deionization channel 172, and/or the third deionization channel 173 may be discharged to the outside of the deionization device 100 through the device outlet 182.

The water treatment apparatus 1 may include a water source 15 which stores raw water or to which raw water is supplied from outside. The raw water may include water that is to be treated by the water treatment apparatus 1.

The water treatment apparatus 1 may include a pump 16 for pumping external water (for example, water supplied from the water source 15).

The water treatment apparatus 1 may include at least one flow path 20 and at least one opening/closing device 30. The at least one flow path 20 may be branched by the at least one opening/closing device 30. For example, the opening/closing device 30 may include a valve.

Water pumped by the pump 16 may flow into flow paths 20 of the water treatment apparatus 1.

In an embodiment, external water may be pumped by the pump 16 and flow into a first flow path 21. The first flow path 21 may receive external water.

The first flow path 21 may be connected to the device inlet 181.

A first opening/closing device 30a may open or close the first flow path 21. The first opening/closing device 30a may block or allow flow of water from the first flow path 21 to the first deionization channel 171, the second deionization channel 172, and/or the third deionization channel 173.

Water flowed into the first deionization channel 171, the second deionization channel 172, and/or the third deionization channel 173 through the first flow path 21 may be discharged to a second flow path 22. The second flow path 22 may be connected to the device outlet 182.

A second opening/closing device 30b may allow water flowing through the second flow path 22 to flow to any of a third flow path 23 or a fourth flow path 24. That is, the second opening/closing device 30b may allow water discharged from the first deionization channel 171, the second deionization channel 172, and/or the third deionization channel 173 to flow to any of the third flow path 23 or the fourth flow path 24. In an embodiment, the second opening/closing device 30b may close the second flow path 22 to prevent water flowing through the second flow path 22 from flowing to the third flow path 23 or the fourth flow path 24.

The third flow path 23 may include a flow path through which purified water (or deionized water) is discharged. The fourth flow path 24 may include a flow path through which polluted water (or wastewater) is discharged.

According to various embodiments, the number of the device inlet 181, the number of the device outlet 182, the kind of the flow path 20, and/or the kind of the opening/closing device 30 are not limited to an example shown in FIG. 1.

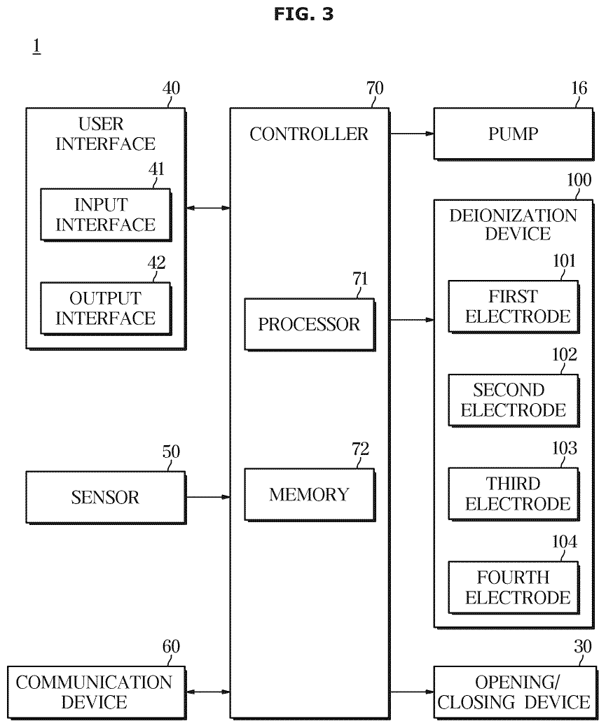

FIG. 3 is a control block diagram of a water treatment apparatus according to an embodiment of the disclosure.

Referring to FIG. 3, the water treatment apparatus 1 according to an embodiment may include a user interface 40, a sensor 50, a communication device 60, the pump 16, the at least one opening/closing device 30, the deionization device 100, and/or a controller 70.

The user interface 40 may include at least one input interface 41 and at least one output interface 42.

The at least one input interface 41 may convert sensory information received from a user into an electrical signal.

The at least one input interface 41 may include a power input interface for turning on the water treatment apparatus 1, an operation input interface for starting an operation of the water treatment apparatus 1, an operation mode selection input interface, and a setting input interface. The at least one input interface 41 may include, for example, a tact switch, a push switch, a slide switch, a toggle switch, a micro switch, a touch switch, a touch pad, a touch screen, a jog dial, and/or a microphone.

The water treatment apparatus 1 may perform a deionization process on water provided to the deionization device 100 in a deionization operation.

The operation mode selection input interface may include an interface for enabling a user to select an operation mode that will first start when the water treatment apparatus 1 starts operating by the operation input interface.

The user who operates the water treatment apparatus 1 may select, through the operation mode selection input interface, an operation mode that will first start from among operation modes of the water treatment apparatus 1.

The setting input interface may include an interface for setting values for various components (for example, the pump 16 and the electrodes, such as the first electrode 101, the second electrode 102, the third electrode 103, and the fourth electrode 104) of the water treatment apparatus 1.

For example, the setting input interface may include an interface for various settings, such as regulating flow velocity of water provided to the deionization device 100 by changing operation RPM of the pump 16 or regulating intensities of voltages applied to the electrodes, such as the first electrode 101, the second electrode 102, the third electrode 103, and the fourth electrode 104.

The at least one output interface 42 may generate sensory information to transfer various information related to an operation of the water treatment apparatus 1 to the user.

For example, the at least one output interface 42 may transfer, to the user, an operation time of the water treatment apparatus 1, information related to settings of the water treatment apparatus 1, and information obtained from the sensor 50. Information of the water treatment apparatus 1 may be output through a screen, an indicator, or a voice. The at least one output interface 42 may include, for example, a liquid crystal display (LCD) panel, a light emitting diode (LED) panel, a speaker, etc.

The sensor 50 may include at least one sensor that obtains information related to an operation state of the water treatment apparatus 1.

For example, the sensor 50 may include a water quality sensor for detecting quality of water discharged through the device outlet 182.

The water quality sensor may include various sensors, such as a turbidity sensor, a Total Dissolved Solids (TDS) sensor, a pH sensor, an electrical conductivity sensor, a hardness sensor, and a flow sensor.

The water quality sensor may be provided on the second flow path 22, the third flow path 23, and/or the fourth flow path 24 to detect quality of water discharged through the device outlet 182. However, the water quality sensor may be positioned at any location capable of sensing quality of water discharged from the deionization device 100.

Information obtained by the sensor 50 may be transferred to the controller 70.

Information obtained by the sensor 50 may also be output through the output interface 42.

The water treatment apparatus 1 may include the communication device 60 for communicating with an external device (for example, a server, a user device, and/or a home appliance) by wire and/or wirelessly.

The communication device 60 may include at least one of a short-range communication module or a long-distance communication module.

The communication device 60 may transmit data to the external device or receive data from the external device. For example, the communication device 60 may establish communication with a server, a user device, and/or a home appliance and transmit/receive various data to/from the server, the user device, and/or the home appliance.

To this end, the communication device 60 may establish a direct (wired) communication channel or a wireless communication channel with the external device, and support communication through the established communication channel. According to an embodiment, the communication device 60 may include a wireless communication module (for example, a cellular communication module, a short-range wireless communication module, or a global navigation satellite system (GNSS) communication module), or a wired communication module (for example, a local area network (LAN) communication module or a power line communication module). A corresponding communication module among the communication modules may communicate with the external electronic device through a first network (for example, a short-range communication network, such as Bluetooth, wireless fidelity (WiFi) direct, or infrared data association (IrDA)) or a second network (for example, a long-distance communication network, such as a legacy cellular network, a 5G network, a next-generation communication network, internet, or a computer network (for example, a local area network (LAN) or a wide area network (WAN)). Such various kinds of communication modules may be integrated into a component (for example, a single chip) or implemented as a plurality of independent components (for example, a plurality of chips).

The short-range wireless communication module may include, but is not limited to, a Bluetooth communication module, a Bluetooth Low Energy (BLE) communication module, a Near Field Communication (NFC) module, a Wireless Local Area Network (WLAN; WiFi) communication module, a Zigbee communication module, an Infrared Data Association (IrDA) communication module, a Wi-Fi Direct (WFD) communication module, a ultrawideband (UWB) communication module, an Ant+ communication module, a microwave (uWave) communication module, etc.

The long-distance wireless communication module may include a communication module that performs various kinds of long-distance communications, and may include a mobile communication device. The mobile communication device may transmit/receive a wireless signal to/from at least one of a base station, an external terminal, or a server on a mobile communication network.

In an embodiment, the communication device 60 may communicate with an external device, such as a server, a mobile device, another home appliance, etc., through a surrounding Access Point (AP). The AP may connect a Local Area Network (LAN) to which the water treatment apparatus 1, a home appliance and/or a user device is connected to a Wide Area Network (WAN) to which a server is connected. The water treatment apparatus 1, the home appliance and/or the user device may be connected to the server through the WAN.

The communication device 60 may receive information about quality of water discharged through the device outlet 182 from the external device.

For example, in the case in which a sensor for detecting quality of water discharged through the device outlet 182 is installed outside the water treatment apparatus 1, the communication device 60 may receive information about quality of water discharged through the device outlet 182 from the sensor installed outside the water treatment apparatus 1.

Information obtained by the communication device 60 may be transferred to the controller 70.

The communication device 60 may transmit information about quality of water obtained by the sensor 50 to an external device (for example, a server, a user device, or a home appliance).

The controller 70 may control various components (for example, the user interface 40, the sensor 50, the communication device 60, the pump 16, the deionization device 100, and/or the at least one opening/closing device 30) of the water treatment apparatus 1. For example, the controller 70 may control voltages that are applied to the first electrode 101 and the second electrode 102.

The controller 70 may include hardware such as a central processing unit (CPU), microcomputer (Micom), or a memory, and software such as a control program. For example, the controller 70 may include at least one memory 72 that stores data in the form of an algorithm or program for controlling operations of components in the water treatment apparatus 1, and at least one processor 71 which performs the above-described operations and operations which will be described below by using the data stored in the at least one memory 92. The memory 72 and the processor 71 may be implemented with separate chips. The processor 71 may include one, two, or more processor chips or one, two, or more processing cores. The memory 72 may include one, two, or more memory chips or one, two, or more memory blocks. Also, the memory 72 and the processor 71 may be implemented with a single chip.

The controller 70 may be electrically connected to the user interface 40, the sensor 50, the communication device 60, the pump 16, the deionization device 100, and/or the at least one opening/closing device 30.

The pump 16 may pump external water to the first flow path 21 according to a control signal from the controller 70.

The at least one opening/closing device 30 may change flow of water flowing to the at least one flow path 20 according to a control signal from the controller 70. The at least one valve 30 may include the first opening/closing device 30a and/or the second opening/closing device 30b.

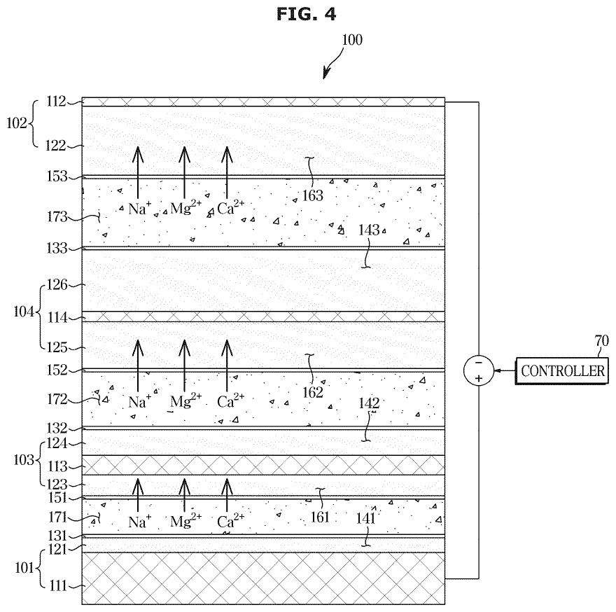

FIG. 4 is a conceptual diagram for describing movements of ions that occur while a water treatment apparatus according to an embodiment of the disclosure performs a deionization operation.

Referring to FIG. 4, the controller 70 may apply a negative voltage to the second current collector 112 in a deionization operation. Applying a negative voltage to the second current collector 112 may include applying a positive voltage to the first current collector 111. While a negative voltage is applied to the second current collector 112 and a positive voltage is applied to the first current collector 111, the side of the third current collector 113 facing the first electrode 101 may be charged with a negative potential, the other side of the third current collector 113 facing the fourth electrode 104 may be charged with a positive potential, the side of the fourth current collector 114 facing the third electrode 103 may be charged with a negative potential, and the other side of the fourth current collector 114 facing the second electrode 102 may be charged with a positive potential.

While a negative voltage is applied to the second current collector 112, cations contained in water in the third deionization channel 173 may move to the third cation channel 163.

The cations contained in the water in the third deionization channel 173 may move to the third cation channel 163 and be adsorbed onto the second porous electrode 122.

While the side of the fourth current collector 114 facing the third electrode 103 is charged with a negative potential, cations contained in water in the second deionization channel 172 may move to the second cation channel 162.

The cations contained in the water in the second deionization channel 172 may move to the second cation channel 162 and be adsorbed onto the fifth porous electrode 125.

While the side of the third current collector 113 facing the first electrode 101 is charged with a negative potential, cations contained in water in the first deionization channel 171 may move to the first cation channel 161.

The cations contained in the water in the first deionization channel 171 may move to the first cation channel 161 and be adsorbed onto the third porous electrode 123.

The cations contained in the water may include, for example, sodium ions (Na⁺), magnesium ions (Mg²⁺), calcium ions (Ca²⁺), etc.

Accordingly, while the water treatment apparatus 1 performs a deionization operation, cations contained in water in the first deionization channel 171, the second deionization channel 172 and/or the third deionization channel 173 may be removed.

While a positive voltage is applied to the first current collector 111, anions contained in water in the first deionization channel 171 may move to the first anion channel 141. While the side of the third current collector 113 facing the fourth electrode 104 is charged with a positive potential, anions contained in water in the second deionization channel 172 may move to the second anion channel 142. While the side of the fourth current collector 114 facing the second electrode 102 is charged with a positive potential, anions contained in water in the third deionization channel 173 may move to the third anion channel 143.

Based on a positive voltage being applied to the first current collector 111 and a negative voltage being applied to the second current collector 112, the deionization device 100 of the water treatment apparatus 1 may remove ions from water passing through the first deionization channel 171, the second deionization channel 172 and/or the third deionization channel 173.

Because a magnitude of a positive voltage applied to the first current collector 111 in the deionization operation is preset within a range in which water in the first anion channel 141 is not electrolyzed, electrolysis of water may not occur in the first electrode 101 which is an anode.

That electrolysis of water does not occur may mean that because a reaction rate of an electrolysis reaction of water is significantly slow, electrolysis of water hardly occurs.

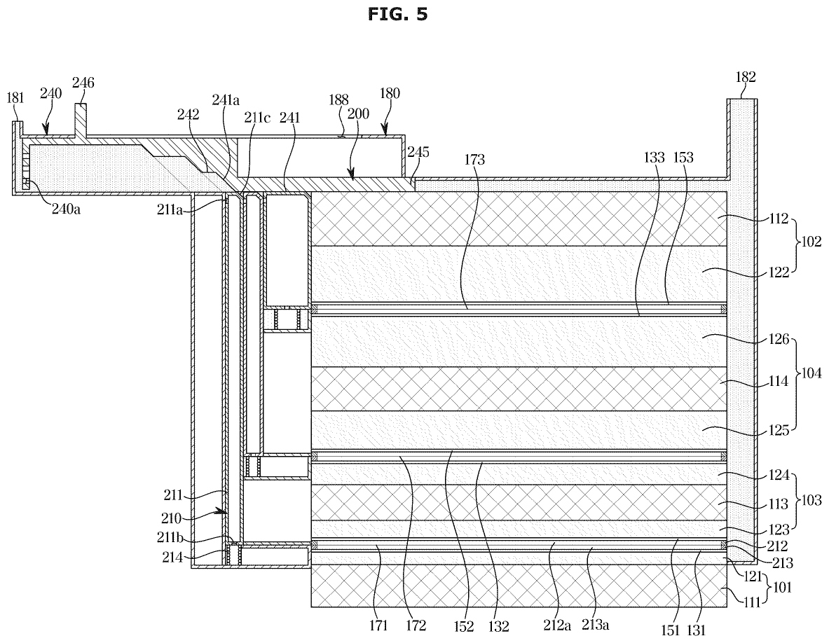

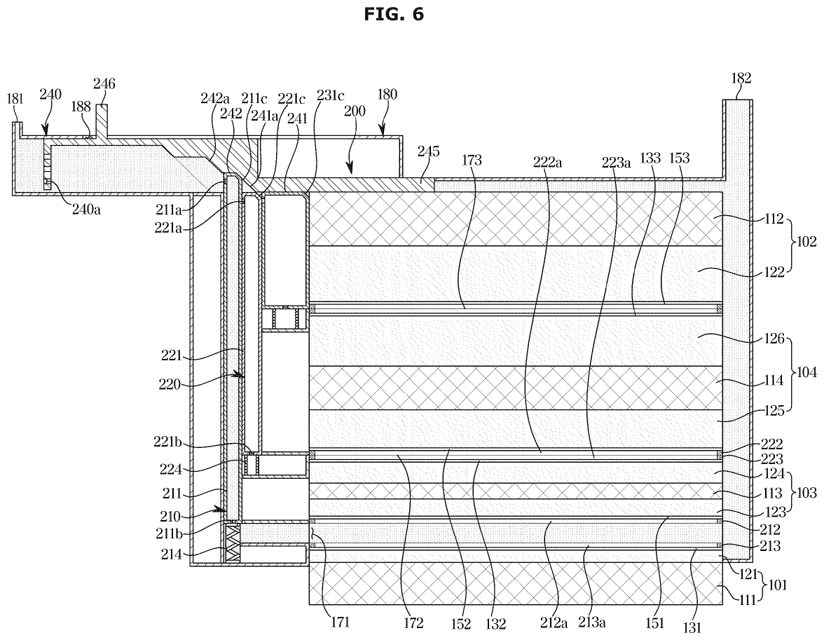

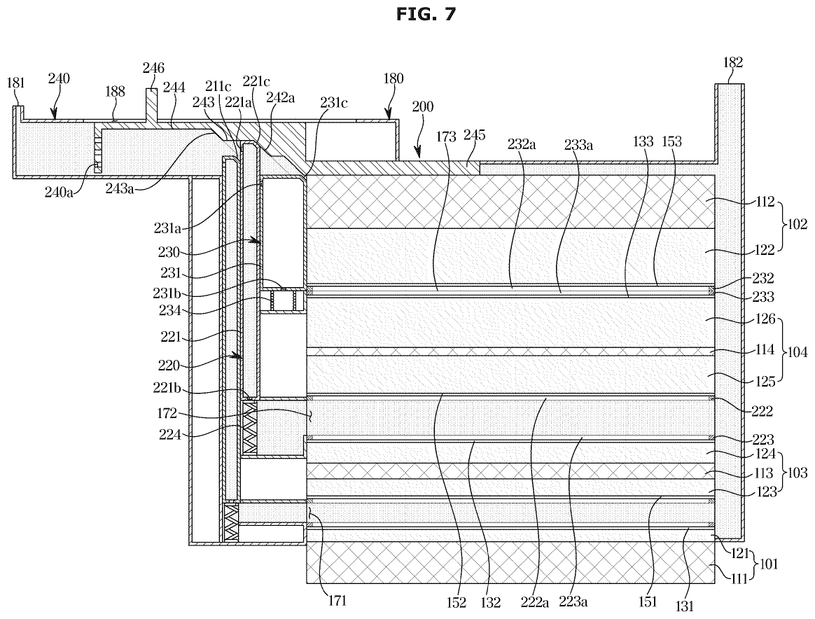

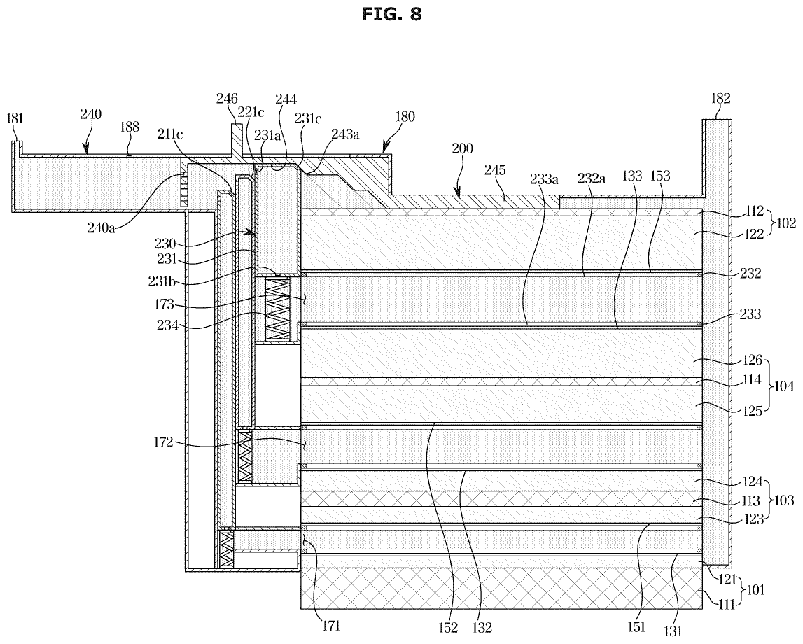

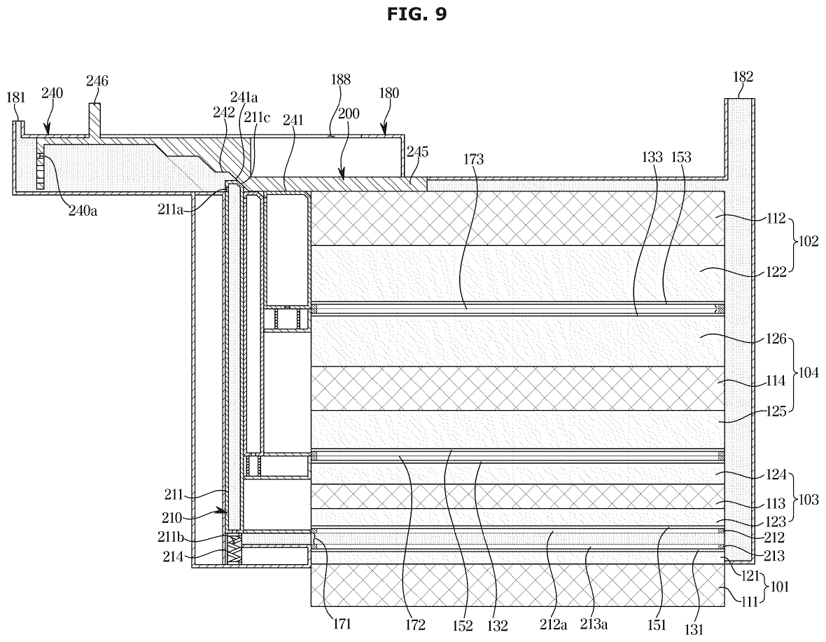

FIG. 5 is a conceptual diagram of a deionization device and a flow regulator while all of deionization channels of a water treatment apparatus according to an embodiment of the disclosure are closed. FIG. 6 is a conceptual diagram of a deionization device and a flow regulator while a first deionization channel of a water treatment apparatus according to an embodiment of the disclosure opens. FIG. 7 is a conceptual diagram of a deionization device and a flow regulator while a first deionization channel and a second deionization channel of a water treatment apparatus according to an embodiment of the disclosure open. FIG. 8 is a conceptual diagram of a deionization device and a flow regulator while a first deionization channel, a second deionization channel, and a third deionization channel of a water treatment apparatus according to an embodiment of the disclosure open. FIG. 9 is a conceptual diagram of a deionization device and a flow regulator while a first deionization channel of a water treatment apparatus according to an embodiment of the disclosure partially open.

Referring to FIG. 5, in the water treatment apparatus 1 according to an embodiment of the disclosure, according to a preset amount of fluid being filled in a flow path from the device inlet 181 toward the deionization device 100 and a preset amount of fluid being filled in a flow path from the deionization device 100 toward the device outlet 182, a flow regulator 200 may close all of the first deionization channel 171, the second deionization channel 172, and the third deionization channel 173. For example, while the water treatment apparatus 1 is in a stop state after operation, the water treatment apparatus 1 may be in a state in which the preset amount of fluid is filled in the flow path from the device inlet 181 toward the deionization device 100 and the preset amount of fluid is filled in the flow path from the deionization device 100 toward the device outlet 182, as in an initial state before operation.

Referring to FIG. 6, in the water treatment apparatus 1 according to an embodiment of the disclosure, according to pressure of a fluid received through the device inlet 181 being first pressure which is relatively low, a regulation body 240 may move to open the first deionization channel 171. In the water treatment apparatus 1 according to an embodiment of the disclosure, according to a flow rate of a fluid received through the device inlet 181 being a first flow rate which is relatively small, the regulation body 240 may move to open the first deionization channel 171. The regulation body 240 may be positioned such that a second body support 242 supports a moving body 211 of a first regulator 210. According to pressure of a fluid received through the device inlet 181 being the first pressure which is relatively low, the water treatment apparatus 1 according to an embodiment of the disclosure may open only the first deionization channel 171 and close the second deionization channel 172 and the third deionization channel 173, thereby improving efficiency.

Referring to FIG. 7, in the water treatment apparatus 1 according to an embodiment of the disclosure, according to pressure of a fluid received through the device inlet 181 being second pressure which is relatively medium, the regulation body 240 may move to additionally open the second deionization channel 172. In the water treatment apparatus 1 according to an embodiment of the disclosure, according to a flow rate of a fluid received through the device inlet 181 being a second flow rate which is relatively medium, the regulation body 240 may move to open the second deionization channel 172. The regulation body 240 may be positioned such that a third body support 243 supports a second moving body 221 of a second regulator 220. According to pressure of a fluid received through the device inlet 181 being the second pressure which is relatively medium, the water treatment apparatus 1 according to an embodiment of the disclosure may open the first deionization channel 171 and the second deionization channel 172 and close the third deionization channel 173, thereby improving efficiency.

Referring to FIG. 8, in the water treatment apparatus 1 according to an embodiment of the disclosure, according to pressure of fluid introduced through the device inlet 181 being third pressure which is relatively high, the regulation body 240 may move to additionally open the third deionization channel 173. In the water treatment apparatus 1 according to an embodiment of the disclosure, according to a flow rate of a fluid received through the device inlet 181 being a third flow rate which is relatively large, the regulation body 240 may move to open the third deionization channel 173. The regulation body 240 may be positioned such that a fourth body support 244 supports a third moving body 231 of a third regulator 230. According to pressure of a fluid received through the device inlet 181 being third pressure which is relatively high, the water treatment apparatus 1 according to an embodiment of the disclosure may open all of the first deionization channel 171, the second deionization channel 172, and the third deionization channel 173, thereby preventing performance deterioration and improving efficiency.

For example, based on an increase of a flow rate of a fluid introduced through the device inlet 181, the flow regulator 200 may sequentially open the first deionization channel 171, the second deionization channel 172, and the third deionization channel 173. Based on an increase of a flow rate of a fluid received through the device inlet 181, the flow regulator 200 may open the first deionization channel 171, the second deionization channel 172, and the third deionization channel 173 sequentially.

The water treatment apparatus 1 according to an embodiment of the disclosure may selectively open the first deionization channel 171, the second deionization channel 172, and the third deionization channel 173 based on pressure of a fluid received through the device inlet 181 and/or based on a flow rate of a fluid received through the device inlet 181, thereby improving efficiency.

Referring to FIG. 9, in the water treatment apparatus 1 according to an embodiment of the disclosure, the regulation body 240 may be movable by a pressure difference between a fluid received through the device inlet 181 and a fluid discharged through the device outlet 182.

For example, in an initial stage in which the water treatment apparatus 1 starts operating, as shown in FIG. 9, the regulation body 240 may move such that the first regulator 210 opens the first deionization channel 171 by pressure of a fluid received through the device inlet 181. For example, the first regulator 210 may partially open the first deionization channel 171. As the first deionization channel 171 partially opens, the first regulator 210 may maintain the state in which the first deionization channel 171 partially opens, when pressure of a fluid received through the device inlet 181 becomes equal to pressure of a fluid discharged through the device outlet 182.

According to an increase of an operation time of the water treatment apparatus 1, scale may be formed in the first electrode 101 and/or the third electrode 103 forming the first deionization channel 171. Due to scale formed in the first electrode 101 and/or the third electrode 103, pressure of a fluid received through the device inlet 181 may become higher than pressure of a fluid discharged through the device outlet 182.

As pressure of a fluid received through the device inlet 181 becomes higher than pressure of a fluid discharged through the device outlet 182, the regulation body 240 may move such that the first regulator 210 further opens the first deionization channel 171. For example, the first regulator 210 may fully open the first deionization channel 171, as shown in FIG. 6. According to the first deionization channel 171 fully opening, the first regulator 210 may maintain the state in which the first deionization channel 171 fully opens, when pressure of a fluid received through the device inlet 181 again becomes equal to pressure of a fluid discharged through the device outlet 182.

According to this configuration, the water treatment apparatus 1 according to an embodiment of the disclosure may regulate a degree of opening of the first deionization channel 171 based on a difference between pressure of a fluid received through the device inlet 181 and pressure of a fluid discharged through the device outlet 182, thereby reducing deterioration of deionization performance.

In addition, the water treatment apparatus 1 according to an embodiment of the disclosure may regulate a degree of opening of the second deionization channel 172, in addition to a degree of opening of the first deionization channel 171, based on a difference between pressure of a fluid received through the device inlet 181 and pressure of a fluid discharged through the device outlet 182, and also regulate a degree of opening of the third deionization channel 173 based on a difference between pressure of a fluid received through the device inlet 181 and pressure of a fluid discharged through the device outlet 182.

Referring to a configuration of the water treatment apparatus 1 according to an embodiment of the disclosure as shown in FIG. 5, FIG. 6, FIG. 7, FIG. 8, and FIG. 9, the water treatment apparatus 1 may include the flow regulator 200. For example, the flow regulator 200 may be installed in the housing 180. The flow regulator 200 may regulate the deionization channels, such as the first deionization channel 171, the second deionization channel 172, and the third deionization channel 173, of the deionization device 100. The flow regulator 200 may regulate the number of deionization channels into which a fluid flows among the plurality of deionization channels, such as the first deionization channel 171, the second deionization channel 172, and the third deionization channel 173, based on a flow rate of a fluid received through the device inlet 181. For example, the flow regulator 200 may increase the number of deionization channels into which a fluid flows among the plurality of deionization channels, such as the first deionization channel 171, the second deionization channel 172, and the third deionization channel 173, based on an increase of a flow rate of a fluid received through the device inlet 181.

Referring to FIG. 5, FIG. 6, and FIG. 9, the flow regulator 200 may include the first regulator 210. The first regulator 210 may regulate the first deionization channel 171. The first regulator 210 may open and/or close the first deionization channel 171. The first regulator 210 may regulate a degree of opening of the first deionization channel 171. At least a portion of the first regulator 210 may be movable relative to the housing 180.

The first regulator 210 may include the first moving body 211. The first moving body 211 may be movable relative to the housing 180. The first moving body 211 may move based on a movement of the regulation body 240. The first moving body 211 may move between a first position of closing the first deionization channel 171 and a second position of opening the first deionization channel 171.

The first moving body 211 may include a first inlet 211a through which a fluid is received. The first inlet 211a may be positioned at one end of the first moving body 211. The first inlet 211a may receive a fluid passing through the device inlet 181 while the first moving body 211 is located at the second position of opening the first deionization channel 171.

The first moving body 211 may include a first outlet 211b through which a fluid is discharged. The first outlet 211b may be positioned at another end of the first moving body 211 which is opposite to one end of the first moving body 211 at which the first inlet 211a is positioned. The first outlet 211b may discharge a fluid to the first deionization channel 171 while the first moving body 211 is located at the second position of opening the first deionization channel 171.

The first moving body 211 may include a first moving guide 211c. The first moving guide 211c may be inclined with respect to a moving direction of the first moving body 211. The first moving body 211 may move based on a movement of the regulation body 240 by the first moving guide 211c.

The first regulator 210 may include a first pressing portion 212 for deforming the third current collector 113. Based on a movement of the first moving body 211, the first pressing portion 212 may apply a force to the third current collector 113. According to the first pressing portion 212 compressing the third current collector 113, the first deionization channel 171 may open. By regulating a degree to which the first pressing portion 212 compresses the third current collector 113, a degree of opening of the first deionization channel 171 may be regulated.

The first pressing portion 212 may be positioned on one side of the third electrode 103 facing the first electrode 101. At least a portion of the first pressing portion 212 may extend along the third electrode 103. At least a portion of the first pressing portion 212 may extend along the first deionization channel 171. The first cation exchange membrane 151 may be positioned between the first pressing portion 212 and the third electrode 103.

The first pressing portion 212 may include a first cation passage part 212a. The first cation passage part 212a may allow cations to pass therethrough. Through the first cation passage part 212a, cations may move between the first deionization channel 171 and the third porous electrode 123. For example, the first cation passage part 212a may include a material through which cations may pass. For example, the first cation passage part 212a may include at least one of a hole, a slit, an aperture, or an opening.

The first pressing portion 212 may be provided as a separate component from the first moving body 211 or may be integrated into the first moving body 211.

The first regulator 210 may include a first fixing body 213. The first fixing body 213 may be fixed to the housing 180. The first fixing body 213 may be positioned on one side of the first electrode 101 facing the third electrode 103. At least a portion of the first fixing body 213 may extend along the first electrode 101. At least a portion of the first fixing body 213 may extend along the first deionization channel 171. The first anion exchange membrane 131 may be positioned between the first fixing body 213 and the first electrode 101.

The first fixing body 213 may include a first anion passage part 213a. The first anion passage part 213a may allow anions to pass therethrough. Through the first anion passage part 213a, anions may move between the first deionization channel 171 and the first porous electrode 121. For example, the first anion passage part 213a may include a material through which anions may pass. For example, the first anion passage part 213a may include at least one of a hole, a slit, an aperture, or an opening.

The first pressing portion 212 may face the first fixing body 213. The first pressing portion 212 may open and/or close the first deionization channel 171 together with the first fixing body 213.

The first regulator 210 may include a first elastic body 214. The first elastic body 214 may apply an elastic force to the first moving body 211. The first elastic body 214 may apply an elastic force to the first moving body 211 in a direction from the first position at which the first moving body 211 closes the first deionization channel 171 toward the second position at which the first moving body 211 opens the first deionization channel 171. For example, one side of the first elastic body 214 may be fixed to the housing 180 and another side may be fixed to the first moving body 211.

Referring to FIG. 6 and FIG. 7, the flow regulator 200 may include the second regulator 220. The second regulator 220 may regulate the second deionization channel 172. The second regulator 220 may open and/or close the second deionization channel 172. The second regulator 220 may regulate a degree of opening of the second deionization channel 172. At least a portion of the second regulator 220 may be movable relative to the housing 180.

The second regulator 220 may include the second moving body 221. The second moving body 221 may be movable relative to the housing 180. The second moving body 221 may move based on a movement of the regulation body 240. The second moving body 221 may move between a first position of closing the second deionization channel 172 and a second position of opening the second deionization channel 172.

The second moving body 221 may include a second inlet 221a through which a fluid is received. The second inlet 221a may be positioned at one end of the second moving body 221. The second inlet 221a may receive a fluid passing through the device inlet 181 while the second moving body 221 is located at the second position of opening the second deionization channel 172.

The second moving body 221 may include a second outlet 221b through which a fluid is discharged. The second outlet 221b may be positioned at another end of the second moving body 221 which is opposite to one end of the second moving body 221 at which the second inlet 221a is positioned. The second outlet 221b may discharge a fluid to the second deionization channel 172 while the second moving body 221 is located at the second position of opening the second deionization channel 172.

The second moving body 221 may include a second moving guide 221c. The second moving guide 221c may be inclined with respect to a moving direction of the second moving body 221. The second moving body 221 may move based on a movement of the regulation body 240 by the second moving guide 221c.

The second regulator 220 may include a second pressing portion 222 for deforming the fourth current collector 114. Based on a movement of the second moving body 221, the second pressing portion 222 may apply a force to the fourth current collector 114. According to the second pressing portion 222 pressing the fourth current collector 114, the second deionization channel 172 may open. By regulating a degree to which the second pressing portion 222 compresses the fourth current collector 114, a degree of opening of the second deionization channel 172 may be regulated.

The second pressing portion 222 may be positioned on one side of the fourth electrode 104 facing the third electrode 103. At least a part of the second pressing portion 222 may extend along the fourth electrode 104. At least a part of the second pressing portion 222 may extend along the second deionization channel 172. The second cation exchange membrane 152 may be positioned between the second pressing portion 222 and the fourth electrode 104.

The second pressing portion 222 may include a second cation passage part 222a. The second cation passage part 222a may allow cations to pass therethrough. Through the second cation passage part 222a, cations may move between the second deionization channel 172 and the fifth porous electrode 125. For example, the second cation passage part 222a may include a material through which cations may pass. For example, the second cation passage part 222a may include at least one of a hole, a slit, an aperture, or an opening.

The second pressing portion 222 may be provided as a separate component from the second moving body 221 or may be integrated into the second moving body 221.

The second regulator 220 may include a second fixing body 223. The second fixing body 223 may be fixed to the housing 180. The second fixing body 223 may be positioned on one side of the third electrode 103 facing the fourth electrode 104. At least a portion of the second fixing body 223 may extend along the third electrode 103. At least a portion of the second fixing body 223 may extend along the second deionization channel 172. The second anion exchange membrane 132 may be positioned between the second fixing body 223 and the third electrode 103.

The second fixing body 223 may include a second anion passage part 223a. The second anion passage part 223a may allow anions to pass therethrough. Through the second anion passage part 223a, anions may move between the second deionization channel 172 and the fourth porous electrode 124. For example, the second anion passage part 223a may include a material through which anions may pass. For example, the second anion passage part 223a may include at least one of a hole, a slit, an aperture, or an opening.

The second pressing portion 222 may face the second fixing body 223. The second pressing portion 222 may open and/or close the second deionization channel 172 together with the second fixing body 223.

The second regulator 220 may include a second elastic body 224. The second elastic body 224 may apply an elastic force to the second moving body 221. The second elastic body 224 may apply an elastic force to the second moving body 221 in a direction from the first position at which the second moving body 221 closes the second deionization channel 172 toward the second position at which the second moving body 221 opens the second deionization channel 172. For example, one side of the second elastic body 224 may be fixed to the housing 180 and another side may be fixed to the second moving body 221.

Referring to FIG. 7 and FIG. 8, the flow regulator 200 may include the third regulator 230. The third regulator 230 may regulate the third deionization channel 173. The third regulator 230 may open and/or close the third deionization channel 173. The third regulator 230 may regulate a degree of opening of the third deionization channel 173. At least a portion of the third regulator 230 may be movable relative to the housing 180.

The third regulator 230 may include the third moving body 231. The third moving body 231 may be movable relative to the housing 180. The third moving body 231 may move based on a movement of the regulating body 240. The third moving body 231 may move between a first position of closing the third deionization channel 173 and a second position of opening the third deionization channel 173.

The third moving body 231 may include a third inlet 231a through which a fluid is received. The third inlet 231a may be positioned at one end of the third moving body 231. The third inlet 231a may receive a fluid passing through the device inlet 181 while the third moving body 231 is located at the second position of opening the third deionization channel 173.

The third moving body 231 may include a third outlet 231b through which a fluid is discharged. The third outlet 231b may be positioned at another end of the third moving body 231 which is opposite to the one end of the third moving body 231 at which the third inlet 231a is positioned. The third outlet 231b may discharge a fluid to the third deionization channel 173 while the third moving body 231 is located at the second position of opening the third deionization channel 173.

The third moving body 231 may include a third moving guide 231c. The third moving guide 231c may be inclined with respect to a moving direction of the third moving body 231. The third moving body 231 may move based on a movement of the regulation body 240 by the third moving guide 231c.

The third regulator 230 may include a third pressing portion 232 for deforming the second current collector 112. Based on a movement of the third moving body 231, the third pressing portion 232 may apply a force to the second current collector 112. According to the third pressing portion 232 pressing the second current collector 112, the third deionization channel 173 may open. By regulating a degree to which the third pressing portion 232 compresses the second current collector 112, a degree of opening of the third deionization channel 173 may be regulated.

The third pressing portion 232 may be positioned on one side of the second electrode 102 facing the fourth electrode 104. At least a part of the third pressing portion 232 may extend along the second electrode 102. At least a part of the third pressing portion 232 may extend along the third deionization channel 173. The third cation exchange membrane 153 may be positioned between the third pressing portion 232 and the second electrode 102.

The third pressing portion 232 may include a third cation passage part 232a. The third cation passage part 232a may allow cations to pass therethrough. Through the third cation passage part 232a, cations may move between the third deionization channel 173 and the second porous electrode 122. For example, the third cation passage part 232a may include a material through which cations may pass. For example, the third cation passage part 232a may include at least one of a hole, a slit, an aperture, or an opening.

The third pressing portion 232 may be provided as a separate component from the third moving body 231 or may be integrated into the third moving body 231.

The third regulator 230 may include a third fixing body 233. The third fixing body 233 may be fixed to the housing 180. The third fixing body 233 may be positioned on one side of the fourth electrode 104 facing the second electrode 102. At least a portion of the third fixing body 233 may extend along the fourth electrode 104. At least a portion of the third fixing body 233 may extend along the third deionization channel 173. The third anion exchange membrane 133 may be positioned between the third fixing body 233 and the fourth electrode 104.

The third fixing body 233 may include a third anion passage part 233a. The third anion passage part 233a may allow cations to pass therethrough. Through the third anion passage part 233a, cations may move between the third deionization channel 173 and the sixth porous electrode 126. For example, the third anion passage part 233a may include a material through which cations may pass. For example, the third anion passage part 233a may include at least one of a hole, a slit, an aperture, or an opening.

The third pressing portion 232 may face the third fixing body 233. The third pressing portion 232 may open and/or close the third deionization channel 173 together with the third fixing body 233.

The third regulator 230 may include a third elastic body 234. The third elastic body 234 may apply an elastic force to the third moving body 231. The third elastic body 234 may apply an elastic force to the third moving body 231 in a direction from the first position at which the third moving body 231 closes the third deionization channel 173 toward the second position at which the third moving body 231 opens the third deionization channel 173. For example, one side of the third elastic body 234 may be fixed to the housing 180 and another side may be fixed to the third moving body 231.

Referring to FIG. 5, FIG. 6, FIG. 7, and FIG. 8, the flow regulator 200 may include the regulation body 240. The regulation body 240 may be movably coupled to the housing 180. The regulation body 240 may move by pressure of a fluid received through the device inlet 181. For example, the regulation body 240 may move to a first position at which all of the deionization channels, such as the first deionization channel 171, the second deionization channel 172, and the third deionization channel 173, are closed, a second position at which the first deionization channel 171 opens and the second deionization channel 172 and the third deionization channel 173 are closed, a third position at which the first deionization channel 171 and the second deionization channel 172 open and the third deionization channel 173 is closed, and a fourth position at which all of the first deionization channel 171, the second deionization channel 172, and the third deionization channel 173 open. The regulation device 240 may move by a difference between pressure of a fluid received through the device inlet 181 and pressure of a fluid discharged through the device outlet 182.

The regulation body 240 may include a body inlet 240a. A fluid flowed into the housing 180 through the device inlet 181 may flow into an inside space of the regulation body 240 through the body inlet 240a. For example, the body inlet 240a may include at least one of a hole, a slit, an aperture, or an opening.

The regulation body 240 may include a first body support 241. The first body support 241 may support the first regulator 210 while the first regulator 210 is located at the first position of closing the first deionization channel 171. The first body support 241 may support the second regulator 220 while the second regulator 220 is located at the first position of closing the second deionization channel 172. The first body support 241 may support the third regulator 230 while the third regulator 230 is located at the first position of closing the third deionization channel 173.

The regulation body 240 may include a first body guide 241a for guiding a movement of the first regulator 210 while the first regulator 210 moves from the first position of closing the first deionization channel 171 to the second position of opening the first deionization channel 171. The first body guide 241a may be inclined with respect to a movement direction of the regulation body 240. The first body guide 241a may interwork with the first moving guide 211c of the first regulator 210. For example, the first body guide 241a may be inclined at 45 degrees with respect to the movement direction of the regulation body 240.

Referring to FIG. 6, the regulation body 240 may include a second body support 242. The second body support 242 may support the first regulator 210 while the first regulator 210 is located at the second position of opening the first deionization channel 171. The second body support 242 may support the first regulator 210 while the regulation body 240 is located at the second position.

The regulation body 240 may include a second body guide 242a for guiding a movement of the second regulator 220 while the second regulator 220 moves from the first position of closing the second deionization channel 172 to the second position of opening the second deionization channel 172. The second body guide 242a may be inclined with respect to the movement direction of the regulation body 240. The second body guide 242a may interwork with the second moving guide 221c of the second regulator 220. For example, the second body guide 242 a may be inclined at 45 degrees with respect to the movement direction of the regulation body 240.

Referring to FIG. 7, the regulation body 240 may include a third body support 243. The third body support 243 may support the second regulator 220 while the second regulator 220 is located at the second position of opening the second deionization channel 172. The third body support 243 may support the second regulator 220 while the regulation body 240 is located at the third position.

The regulation body 240 may include a third body guide 243a for guiding a movement of the third regulator 230 while the third regulator 230 moves from the first position of closing the third deionization channel 173 to the second position of opening the third deionization channel 173. The third body guide 243a may be inclined with respect to the movement direction of the regulation body 240. The third body guide 243a may interwork with the third moving guide 231c of the third regulator 230. For example, the third body guide 243a may be inclined at 45 degrees with respect to the movement direction of the regulation body 240.

Referring to FIG. 8, the regulation body 240 may include the fourth body support 244. The fourth body support 244 may support the third regulator 230 while the third regulator 230 is located at the second position of opening the third deionization channel 173. The fourth body support 244 may support the third regulator 230 while the regulation body 240 is located at the fourth position.

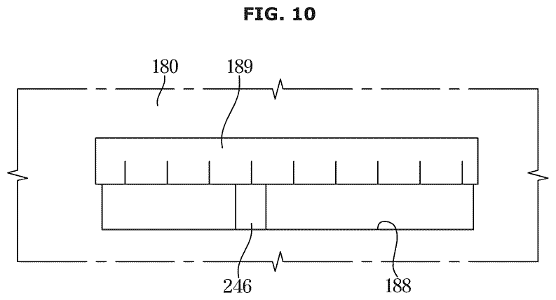

FIG. 10 is an enlarged view of a portion of a water treatment apparatus according to an embodiment of the disclosure where a state display is positioned.

Referring to FIG. 5, FIG. 6, FIG. 7, FIG. 8, FIG. 9, and FIG. 10, the water treatment apparatus 1 according to an embodiment of the disclosure may include a slider 246 and a state display 189 for displaying whether scale has been formed in the deionization device 100 for a user. For example, the slider 246 may be provided in the regulation body 240, and the state display 189 may be provided in the housing 180.

The slider 246 may be inserted into a guide slit 188 formed in the housing 180. The slider 246 may protrude outward from the housing 180. While the regulation body 240 moves in the state in which the slider 246 is inserted into the guide slit 188, the slider 246 may move. The movement of the slider 246 may be guided by the guide slit 188. For example, the guide slit 188 may be formed by penetrating a portion of the housing 180.

The state display 189 may be adjacent to the guide slit 188 of the housing 180. For example, the state display 189 may include a display panel, may be embossed and/or engraved, or may be formed by being printed on an outer surface of the housing 180. As an example, the state display 189 may include a plurality of scales.

In the water treatment apparatus 1 according to an embodiment of the disclosure, while no scale is formed in the deionization device 100, the slider 246 may be located at a preset position relative to the state display 189 based on a flow rate of a fluid received through the device inlet 181. While a flow rate of a fluid received through the device inlet 181 increases, the slider 246 of the regulation body 240 may move to the right in FIG. 10.

For example, according to scale being formed in the deionization device 100, pressure of a fluid received through the device inlet 181 may increase and the slider 246 of the regulation body 240 may deviate from the preset position relative to the state display 189. For example, the slider 246 may further move to the right from the preset position according to a flow rate of a fluid received through the device inlet 181, and a user may identify that scale has been formed in the deionization device 100 based on a position of the slider 246. The user who has identified that scale has been formed in the deionization device 100 may perform flushing for removing scale as necessary. Flushing may include supplying citric acid, etc. for braking down main ingredients of scale to the water treatment apparatus 1.

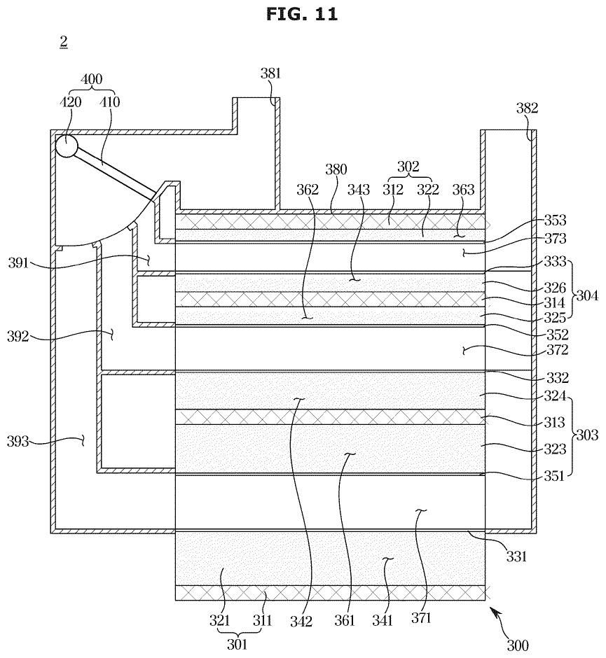

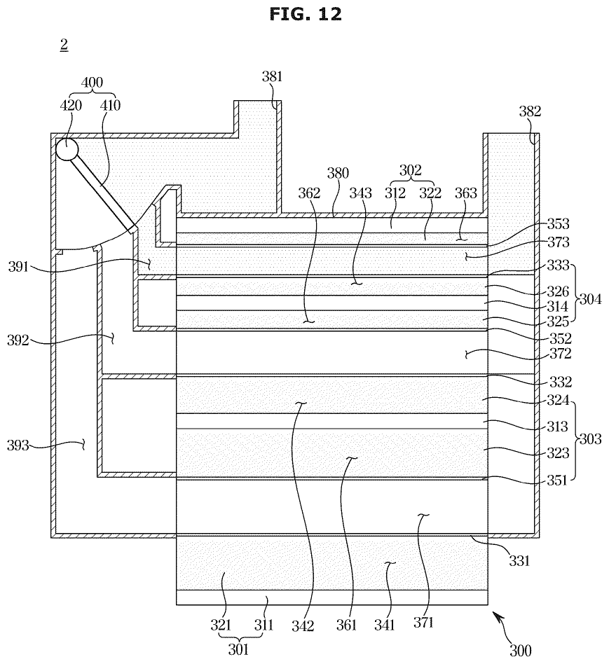

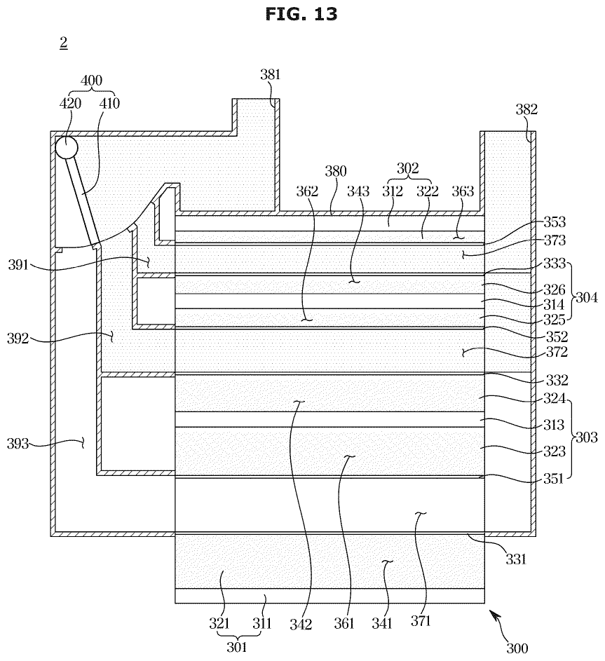

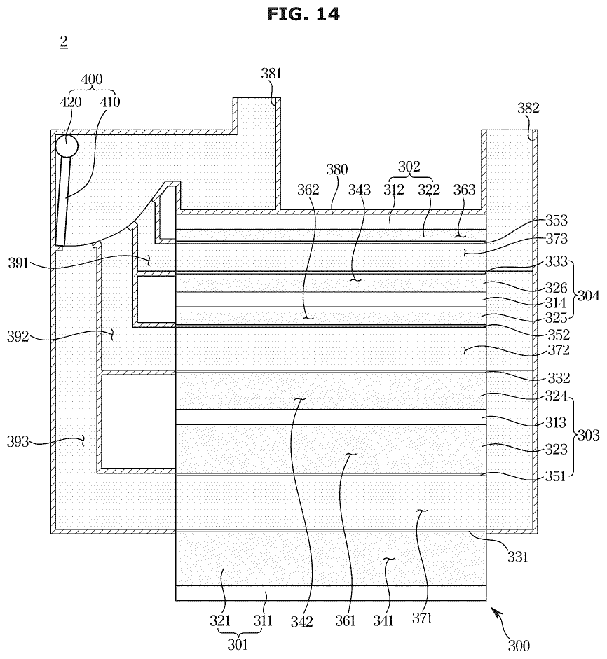

FIG. 11 is a conceptual diagram of a deionization device and a flow regulator while all of a first deionization channel, a second deionization channel, and a third deionization channel of a water treatment apparatus according to an embodiment of the disclosure are closed. FIG. 12 is a conceptual diagram of a deionization device and a flow regulator while a first deionization channel of a water treatment apparatus according to an embodiment of the disclosure opens. FIG. 13 is a conceptual diagram of a deionization device and a flow regulator while a first deionization channel and a second deionization channel of a water treatment apparatus according to an embodiment of the disclosure open. FIG. 14 is a conceptual diagram of a deionization device and a flow regulator while all of a first deionization channel, a second deionization channel, and a third deionization channel of a water treatment apparatus according to an embodiment of the disclosure open.

Referring to FIG. 11, a water treatment apparatus 2 according to an embodiment may include a deionization device 300. For example, the deionization device 300 may include a plurality of electrodes, such as a first electrode 301, a second electrode 302, a third electrode 303, and a fourth electrode 304, and a plurality of deionization channels, such as a first deionization channel 371, a second deionization channel 372, and a third deionization channel 373, that may be formed between a plurality of electrodes, such as a first electrode 301, a second electrode 302, a third electrode 303, and a fourth electrode 304.

The deionization device 300 may include a first electrode 301, a second electrode 302, and an intermediate electrode, such as any one or more of the third electrode 303 and the fourth electrode 304. The intermediate electrode may be positioned between the first electrode 301 and the second electrode 302.

For example, the intermediate electrode may include the third electrode 303 and the fourth electrode 304. In FIG. 11, the intermediate electrode is shown as including the third electrode 303 and the fourth electrode 304. However, the intermediate electrode may include only one electrode or may include three or more electrodes.

The first electrode 301 may face the third electrode 303. The first electrode 301 and the third electrode 303 may form an electric field. The third electrode 303 may face the fourth electrode 304. The third electrode 303 and the fourth electrode 304 may form an electric field. The fourth electrode 304 may face the second electrode 302. The fourth electrode 304 and the second electrode 302 may form an electric field.

The first electrode 301 may include a first current collector 311 and a first porous electrode 321. The first electrode 301 may be a positive electrode (anode) or a negative electrode (cathode).

In an embodiment, the first current collector 311 may include an electrode plate electrically connected to the first porous electrode 321. The electrode plate may include a metal plate and/or a non-metal plate.

The first current collector 311 may include a conductor. For example, the first current collector 311 may include graphite.

The first porous electrode 321 may include a solid electrode including a void space. The first porous electrode 321 may include a material that is easy to adsorb ions. For example, the first porous electrode 321 may include a carbon porous electrode.

For example, the first porous electrode 321 may include a carbon-based active material including at least one selected from among activated carbon, graphene, carbon nanotubes, carbon fibers, or carbon aerogel. The carbon-based active material may be manufactured in powder form and used.

The second electrode 302 may include a second current collector 312 and a second porous electrode 322. The second electrode 302 may be a positive electrode (anode) or a negative electrode (cathode).

In an embodiment, the second current collector 312 may include an electrode plate electrically connected to the second porous electrode 322. The electrode plate may include a metal plate and/or a non-metal plate.

The second current collector 312 may include a conductor. The second current collector 312 may include the same composition as the first current collector 311. For example, the second current collector 312 may include graphite. In an embodiment, the second current collector 312 may include a material that is different from that of the first current collector 311.

The second porous electrode 322 may include a solid electrode including a void space. The second porous electrode 322 may include the same composition as the first porous electrode 321. The second porous electrode 322 may include a material that is easy to adsorb ions. For example, the second porous electrode 322 may include a carbon porous electrode. In an embodiment, the second porous electrode 322 may include a material that is different from that of the first porous electrode 321.

For example, the second porous electrode 322 may include a carbon-based active material including at least one selected from among activated carbon, graphene, carbon nanotubes, carbon fibers, or carbon aerogel. The carbon-based active material may be manufactured in powder form and used.

The third electrode 303 may include a third current collector 313, a third porous electrode 323, and a fourth porous electrode 324. A portion of the third electrode 303 may be a positive electrode (anode) or a negative electrode (cathode), and correspondingly, the remaining portion may be a negative electrode (cathode) or a positive electrode (anode).

The third porous electrode 323 may be positioned on one side of the third current collector 313, and the fourth porous electrode 324 may be positioned on another side of the third current collector 313 which is opposite to the one side of the third current collector 313. For example, the third porous electrode 323 may be positioned on one side of the third current collector 313 facing the first electrode 301, and the fourth porous electrode 324 may be positioned on one side of the third current collector 313 facing the fourth electrode 304.

In an embodiment, the third current collector 313 may include an electrode plate electrically connected to the third porous electrode 323 and the fourth porous electrode 324. The electrode plate may include a metal plate and/or a non-metal plate.

The third current collector 313 may include a conductor. The third current collector 313 may include the same composition as the first current collector 311 and/or the second current collector 312. For example, the third current collector 313 may include graphite. In an embodiment, the third current collector 313 may include a material that is different from that of the first current collector 311 and/or the second current collector 312.

The third porous electrode 323 may include a solid electrode including a void space. The third porous electrode 323 may include the same composition as the first porous electrode 321 and/or the second porous electrode 322. The third porous electrode 323 may include a material that is easy to adsorb ions. For example, the third porous electrode 323 may include a carbon porous electrode. In an embodiment, the third porous electrode 323 may include a material that is different from that of the first porous electrode 321 and/or the second porous electrode 322.

For example, the third porous electrode 323 may include a carbon-based active material including at least one selected from among activated carbon, graphene, carbon nanotubes, carbon fibers, or carbon aerogel. The carbon-based active material may be manufactured in powder form and used.

The fourth porous electrode 324 may include a solid electrode including a void space. The fourth porous electrode 324 may include the same composition as the first porous electrode 321, the second porous electrode 322, and/or the third porous electrode 323. The fourth porous electrode 324 may include a material that is easy to adsorb ions. For example, the fourth porous electrode 324 may include a carbon porous electrode. In an embodiment, the fourth porous electrode 324 may include a material that is different from that of the first porous electrode 321, the second porous electrode 322, and/or the third porous electrode 323.

For example, the fourth porous electrode 324 may include a carbon-based active material including at least one selected from among activated carbon, graphene, carbon nanotubes, carbon fibers, or carbon aerogel. The carbon-based active material may be manufactured in powder form and used.

The fourth electrode 304 may include a fourth current collector 314, a fifth porous electrode 325, and a sixth porous electrode 326. A portion of the fourth electrode 304 may be a positive electrode (anode) or a negative electrode (cathode), and correspondingly, the remaining portion may be a negative electrode (cathode) or a positive electrode (anode).

The fifth porous electrode 325 may be positioned on one side of the fourth current collector 314, and the sixth porous electrode 326 may be positioned on another side of the fourth current collector 314 which is opposite to the one side of the fourth current collector 314. For example, the fifth porous electrode 325 may be positioned on one side of the fourth current collector 314 facing the third electrode 303, and the sixth porous electrode 326 may be positioned on one side of the fourth current collector 314 facing the second electrode 302.

In an embodiment, the fourth current collector 314 may include an electrode plate electrically connected to the fifth porous electrode 325 and the sixth porous electrode 326. The electrode plate may include a metal plate and/or a non-metal plate.

The fourth current collector 314 may include a conductor. The fourth current collector 314 may include the same composition as the first current collector 311, the second current collector 312, and/or the third current collector 313. For example, the fourth current collector 314 may include graphite. In an embodiment, the fourth current collector 314 may include a material that is different from that of the first current collector 311, the second current collector 312, and/or the third current collector 313.

The fifth porous electrode 325 may include a solid electrode including a void space. The fifth porous electrode 325 may include the same composition as the first porous electrode 321, the second porous electrode 322, the third porous electrode 323, and/or the fourth porous electrode 324. The fifth porous electrode 325 may include a material that is easy to adsorb ions. For example, the fifth porous electrode 325 may include a carbon porous electrode. In an embodiment, the fifth porous electrode 325 may include a material that is different from that of the first porous electrode 321, the second porous electrode 322, the third porous electrode 323, and/or the fourth porous electrode 324.

As an example, the fifth porous electrode 325 may include a carbon-based active material including at least one selected from among activated carbon, graphene, carbon nanotubes, carbon fibers, or carbon aerogel. The carbon-based active material may be manufactured in powder form and used.

The sixth porous electrode 326 may include a solid electrode including a void space. The sixth porous electrode 326 may include the same composition as the first porous electrode 321, the second porous electrode 322, the third porous electrode 323, the fourth porous electrode 324, and/or the fifth porous electrode 325. The sixth porous electrode 326 may include a material that is easy to adsorb ions. For example, the sixth porous electrode 326 may include a carbon porous electrode. In an embodiment, the sixth porous electrode 326 may include a material that is different from that of the first porous electrode 321, the second porous electrode 322, the third porous electrode 323, the fourth porous electrode 324, and/or the fifth porous electrode 325.

For example, the sixth porous electrode 326 may include a carbon-based active material including at least one selected from among activated carbon, graphene, carbon nanotubes, carbon fibers, or carbon aerogel. The carbon-based active material may be manufactured in powder form and used.

For example, the first porous electrode 321, the second porous electrode 322, the third porous electrode 323, the fourth porous electrode 324, the fifth porous electrode 325, and the sixth porous electrode 326 may have different ion storage capacities. For example, the first porous electrode 321, the second porous electrode 322, the third porous electrode 323, the fourth porous electrode 324, the fifth porous electrode 325, and the sixth porous electrode 326 may have different sizes.

For example, the second porous electrode 322 may have the same size as the sixth porous electrode 326 or a larger size than the sixth porous electrode 326. For example, the sixth porous electrode 326 may have the same size as the fifth porous electrode 325 or a larger size than the fifth porous electrode 325. For example, the fifth porous electrode 325 may have the same size as the fourth porous electrode 324 or a larger size than the fourth porous electrode 324. For example, the fourth porous electrode 324 may have the same size as the third porous electrode 323 or a larger size than the third porous electrode 323. For example, the third porous electrode 323 may have the same size as the first porous electrode 321 or a larger size than the first porous electrode 321.

For example, the porous electrodes, such as the first porous electrode 321, the second porous electrode 322, the third porous electrode 323, the fourth porous electrode 324, the fifth porous electrode 325, and the sixth porous electrode 326, may be prepared with various thicknesses by controlling a ratio of materials, controlling viscosity of slurry for coating, controlling a width of a coating blade, or controlling drying conditions.

The deionization device 300 may include a first anion exchange membrane 331. The first anion exchange membrane 331 may include a membrane that transmits only anions among cations and anions. Because the first anion exchange membrane 331 has positive charges, the first anion exchange membrane 331 may repel cations not to transmit the cations and may transmit only anions.

For example, the first anion exchange membrane 331 may be positioned adjacent to the first electrode 301. The first anion exchange membrane 331 may be positioned on another side of the first porous electrode 321 which is opposite to one side of the first porous electrode 321 on which the first current collector 311 is positioned.

The deionization device 300 may include a first anion channel 341 formed by the first current collector 311 and the first anion exchange membrane 331. The first anion channel 341 may include a space between the first current collector 311 and the first anion exchange membrane 331. The first porous electrode 321 may be provided in the first anion channel 341.

The deionization device 300 may include a second anion exchange membrane 332. The second anion exchange membrane 332 may include a membrane that transmits only anions among cations and anions. Because the second anion exchange membrane 332 has positive charges, the second anion exchange membrane 332 may repel cations not to transmit the cations and may transmit only anions.

For example, the second anion exchange membrane 332 may be positioned adjacent to the third electrode 303. The second anion exchange membrane 332 may be positioned on another side of the fourth porous electrode 324 which is opposite to one side of the fourth porous electrode 324 on which the third current collector 313 is positioned.

The deionization device 300 may include a second anion channel 342 formed by the third current collector 313 and the second anion exchange membrane 332. The second anion channel 342 may include a space between the third current collector 313 and the second anion exchange membrane 332. The fourth porous electrode 324 may be provided in the second anion channel 342.

The deionization device 300 may include a third anion exchange membrane 333. The third anion exchange membrane 333 may include a membrane that transmits only anions among cations and anions. Because the third anion exchange membrane 333 has positive charges, the third anion exchange membrane 333 may repel cations not to transmit the cations and may transmit only anions.

For example, the third anion exchange membrane 333 may be positioned adjacent to the fourth electrode 304. The third anion exchange membrane 333 may be positioned on another side of the sixth porous electrode 326 which is opposite to one side of the sixth porous electrode 326 on which the fourth current collector 314 is positioned.

The deionization device 300 may include a third anion channel 343 formed by the fourth current collector 314 and the third anion exchange membrane 333. The third anion channel 343 may include a space between the fourth current collector 314 and the third anion exchange membrane 333. The sixth porous electrode 326 may be provided in the third anion channel 343.

The deionization device 300 may include a first cation exchange membrane 351. The first cation exchange membrane 351 may include a membrane that transmits only cations among cations and anions. Because the first cation exchange membrane 351 has negative charges, the first cation exchange membrane 351 may repel anions not to transmit the anions and may transmit only cations.

For example, the first cation exchange membrane 351 may be positioned adjacent to the third electrode 303. The first cation exchange membrane 351 may be positioned on another side of the third porous electrode 323 which is opposite to one side of the third porous electrode 323 on which the third current collector 313 is positioned.

The deionization device 300 may include a first cation channel 361 formed by the third current collector 313 and the first cation exchange membrane 351. The first cation channel 361 may include a space between the third current collector 313 and the first cation exchange membrane 351. The third porous electrode 323 may be provided in the first cation channel 361.

The deionization device 300 may include a second cation exchange membrane 352. The second cation exchange membrane 352 may include a membrane that transmits only cations among cations and anions. Because the second cation exchange membrane 352 has negative charges, the second cation exchange membrane 352 may repel anions not to transmit the anions and may transmit only cations.

For example, the second cation exchange membrane 352 may be positioned adjacent to the fourth electrode 304. The second cation exchange membrane 352 may be positioned on another side of the fifth porous electrode 325 which is opposite to one side of the fifth porous electrode 325 on which the fourth current collector 314 is positioned.

The deionization device 300 may include a second cation channel 362 formed by the fourth current collector 314 and the second cation exchange membrane 352. The second cation channel 362 may include a space between the fourth current collector 314 and the second cation exchange membrane 352. The fifth porous electrode 325 may be provided in the second cation channel 362.

The deionization device 300 may include a third cation exchange membrane 353. The third cation exchange membrane 353 may include a membrane that transmits only cations among cations and anions. Because the third cation exchange membrane 353 has negative charges, the third cation exchange membrane 353 may repel anions not to transmit the anions and may transmit only cations.

For example, the third cation exchange membrane 353 may be positioned adjacent to the second electrode 302. The third cation exchange membrane 353 may be positioned on another side of the second porous electrode 322 which is opposite to one side of the second porous electrode 322 on which the second current collector 312 is positioned.

The deionization device 300 may include a third cation channel 363 formed by the second current collector 312 and the third cation exchange membrane 353. The third cation channel 363 may include a space between the second current collector 312 and the third cation exchange membrane 353. The second porous electrode 322 may be provided in the third cation channel 363.

The first anion exchange membrane 331, the second anion exchange membrane 332, the third anion exchange membrane 333, the first cation exchange membrane 351, the second cation exchange membrane 352, and/or the third cation exchange membrane 353 may include a membrane through which a fluid passes. For example, the first anion exchange membrane 331, the second anion exchange membrane 332, the third anion exchange membrane 333, the first cation exchange membrane 351, the second cation exchange membrane 352, and/or the third cation exchange membrane 353 may include a synthetic resin membrane.

The deionization device 300 may include a first deionization channel 371. The first deionization channel 371 may be formed by the first anion exchange membrane 331 and the first cation exchange membrane 351. The first deionization channel 371 may include a space between the first anion exchange membrane 331 and the first cation exchange membrane 351. The first electrode 301 may be positioned on one side of the first deionization channel 371, and the third electrode 303 may be positioned on another side of the first deionization channel 371 which is opposite to the one side of the first deionization channel 371.

The deionization device 300 may include a second deionization channel 372. The second deionization channel 372 may be formed by the second anion exchange membrane 332 and the second cation exchange membrane 352. The second deionization channel 372 may include a space between the second anion exchange membrane 332 and the second cation exchange membrane 352. The third electrode 303 may be positioned on one side of the second deionization channel 372, and the fourth electrode 304 may be positioned on another side of the second deionization channel 372 which is opposite to the one side of the second deionization channel 372.

The deionization device 300 may include a third deionization channel 373. The third deionization channel 373 may be formed by the third anion exchange membrane 333 and the third cation exchange membrane 353. The third deionization channel 373 may include a space between the third anion exchange membrane 333 and the third cation exchange membrane 353. The fourth electrode 304 may be positioned on one side of the third deionization channel 373, and the second electrode 302 may be positioned on another side of the third deionization channel 373 which is opposite to the one side of the third deionization channel 373.

For example, the first deionization channel 371 may be larger than the second deionization channel 372. A gap between the first electrode 301 and the third electrode 303, which forms the first deionization channel 371, may be larger than a gap between the third electrode 303 and the fourth electrode 304, which forms the second deionization channel 372.

First deionization performance in which ions are removed from a fluid passing through the first deionization channel 371 may be equal to or higher than second deionization performance in which ions are removed from a fluid passing through the second deionization channel 372. Because the first deionization channel 371 has a larger gap than the second deionization channel 372, the first deionization channel 371 may have lower deionization performance. However, because the ion storage capacities of the first electrode 301 and the third electrode 303 forming the first deionization channel 371 are larger than the ion storage capacities of the third electrode 303 and the fourth electrode 304 forming the second deionization channel 372, the deionization performance of the first deionization channel 371 may be equal to or higher than the deionization performance of the second deionization channel 372.

For example, the second deionization channel 372 may be larger than the third deionization channel 373. A gap between the third electrode 303 and the fourth electrode 304, which forms the second deionization channel 372, may be larger than a gap between the fourth electrode 304 and the second electrode 302, which forms the third deionization channel 373.

Second deionization performance in which ions are removed from a fluid passing through the second deionization channel 372 may be equal to or higher than third deionization performance in which ions are removed from a fluid passing through the third deionization channel 373. Because the second deionization channel 372 has a larger gap than the third deionization channel 373, the second deionization channel 372 may have lower deionization performance. However, because the ion storage capacities of the third electrode 303 and the fourth electrode 304 forming the second deionization channel 372 are larger than the ion storage capacities of the fourth electrode 304 and the second electrode 302 forming the third deionization channel 373, the deionization performance of the second deionization channel 372 may be equal to or higher than the deionization performance of the third deionization channel 373.

The first anion channel 341, the second anion channel 342, the third anion channel 343, the first cation channel 361, the second cation channel 362, the third cation channel 363, the first deionization channel 371, the second deionization channel 372, and/or the third deionization channel 373 may be replaced with terms such as compartments, spaces, rooms, or chambers, in that the first anion channel 341, the second anion channel 342, the third anion channel 343, the first cation channel 361, the second cation channel 362, the third cation channel 363, the first deionization channel 371, the second deionization channel 372, and/or the third deionization channel 373 are separated from each other by the ion exchange membranes, such as the first anion exchange membrane 331, the second anion exchange membrane 332, the third anion exchange membrane 333, the first cation exchange membrane 351, the second cation exchange membrane 352, and the third cation exchange membrane 353.

The first anion channel 341, the first cation channel 361, and the first deionization channel 371 may be fluidically connected to each other. For example, a fluid in the first deionization channel 371 may move to the first anion channel 341 and/or the first cation channel 361, and conversely, a fluid in the first anion channel 341 and/or the first cation channel 361 may move to the first deionization channel 371.

The second anion channel 342, the second cation channel 362, and the second deionization channel 372 may be fluidically connected to each other. For example, a fluid in the second deionization channel 372 may move to the second anion channel 342 and/or the second cation channel 362, and conversely, a fluid in the second anion channel 342 and/or the second cation channel 362 may move to the second deionization channel 372.

The third anion channel 343, the third cation channel 363, and the third deionization channel 373 may be fluidically connected to each other. For example, a fluid in the third deionization channel 373 may move to the third anion channel 343 and/or the third cation channel 363, and conversely, a fluid in the third anion channel 343 and/or the third cation channel 363 may move to the third deionization channel 373.

While a positive voltage is applied to the first current collector 311, the first electrode 301 may become a positive electrode (anode), and while a negative voltage is applied to the second current collector 312, the second electrode 302 may become a negative electrode (cathode).

Applying a positive voltage to the first current collector 311 and applying a negative voltage to the second current collector 312 may include causing a potential of the first current collector 311 to be higher than that of the second current collector 312.

Applying a positive voltage to the first current collector 311 may include applying a negative voltage to the second current collector 312.

Applying a positive voltage to the first current collector 311 and applying a negative voltage to the second current collector 312 may include applying a positive voltage between the first current collector 311 and the second current collector 312.

Applying a positive voltage between the first current collector 311 and the second current collector 312 may include causing a potential of the first current collector 311 to be higher than that of the second current collector 312.

While a positive voltage is applied to the first current collector 311 and a negative voltage is applied to the second current collector 312, one side of the third current collector 313 may be charged with a negative voltage and the opposite side may be charged with a positive voltage. For example, a side of the third electrode 303 facing the first electrode 301 may become a cathode, and another side facing the fourth electrode 304 may become an anode.

While a positive voltage is applied to the first current collector 311 and a negative voltage is applied to the second current collector 312, a side of the fourth current collector 314 may be charged with a negative potential, and the opposite side may be charged with a positive voltage. For example, a side of the fourth electrode 304 facing the third electrode 303 may become a cathode, and another side facing the second electrode 302 may become an anode.

While a positive voltage is applied to the first current collector 311 and a first side of the third current collector 313 is charged with a negative potential, cations in the first deionization channel 371 may move to the first cation channel 361 and anions in the first deionization channel 371 may move to the first anion channel 341.

The anions moved into the first anion channel 341 while a positive voltage is applied to the first current collector 311 may be adsorbed onto the first porous electrode 321, and the cations moved into the first cation channel 361 while the first side of the third current collector 313 is charged with a negative potential may be adsorbed onto the third porous electrode 323.

While a second side of the third current collector 313 is charged with a positive potential and a first side of the fourth current collector 314 is charged with a negative potential, cations in the second deionization channel 372 may move to the second cation channel 362, and anions in the second deionization channel 372 may move to the second anion channel 342.

The anions moved to the second anion channel 342 while the second side of the third current collector 313 is charged with a positive potential may be adsorbed onto the fourth porous electrode 324, and the cations moved to the second cation channel 362 while the first side of the fourth current collector 314 is charged with a negative potential may be adsorbed onto the fifth porous electrode 325.

While the second side of the fourth current collector 314 is charged with a positive potential and a negative voltage is applied to the second current collector 312, cations in the third deionization channel 373 may move to the third cation channel 363, and anions in the third deionization channel 373 may move to the third anion channel 343.

The anions moved into the third anion channel 343 while the second side of the fourth current collector 314 is charged with a positive potential may be adsorbed onto the sixth porous electrode 326, and the cations moved to the third cation channel 363 while a negative voltage is applied to the second current collector 312 may be adsorbed onto the second porous electrode 322.

While a negative voltage is applied to the first current collector 311, the first electrode 301 may become a negative electrode (cathode), and while a positive voltage is applied to the second current collector 312, the second electrode 302 may become a positive electrode (anode).

Applying a negative voltage to the first current collector 311 and applying a positive voltage to the second current collector 312 may include causing a potential of the first current collector 311 to be lower than that of the second current collector 312.

Applying a negative voltage to the first current collector 311 may include applying a positive voltage to the second current collector 312.

Applying a negative voltage to the first current collector 311 and applying a positive voltage to the second current collector 312 may include applying a negative voltage between the first current collector 311 and the second current collector 312.

Applying a negative voltage between the first current collector 311 and the second current collector 312 may include causing a potential of the first current collector 311 to be lower than that of the second current collector 312.

While a negative voltage is applied to the first current collector 311 and a positive voltage is applied to the second current collector 312, one side of the third current collector 313 may be charged with a positive voltage and the opposite side may be charged with a negative voltage. For example, a side of the third electrode 303 facing the first electrode 301 may become an anode, and another side facing the fourth electrode 304 may become a cathode.

While a negative voltage is applied to the first current collector 311 and a positive voltage is applied to the second current collector 312, one side of the fourth current collector 314 may be charged with a positive voltage and the opposite side may be charged with a negative voltage. For example, a side of the fourth electrode 304 facing the third electrode 303 may become an anode, and another side facing the second electrode 302 may become a cathode.

While a negative voltage is applied to the first current collector 311 and the first side of the third current collector 313 is charged with a positive potential, cations in the first cation channel 361 may move to the first deionization channel 371, and anions in the first anion channel 341 may move to the first deionization channel 371.

By applying a negative voltage to the first current collector 311, anions adsorbed onto the first porous electrode 321 may be desorbed from the first porous electrode 321, and by charging the first side of the third current collector 313 with a positive potential, cations adsorbed onto the third porous electrode 323 may be desorbed from the third porous electrode 323.

While the second side of the third current collector 313 is charged with a negative potential and the first side of the fourth current collector 314 is charged with a positive potential, cations in the second cation channel 362 may move to the second deionization channel 372 and anions in the second anion channel 342 may move to the second deionization channel 372.

By charging the second side of the third current collector 313 with a negative potential, anions adsorbed onto the fourth porous electrode 324 may be desorbed from the fourth porous electrode 324, and by charging the first side of the fourth current collector 314 with a positive potential, cations adsorbed onto the fifth porous electrode 325 may be desorbed from the fifth porous electrode 325.

While the second side of the fourth current collector 314 is charged with a negative potential and a negative voltage is applied to the second current collector 312, cations in the third cation channel 363 may move to the third deionization channel 373 and anions in the third anion channel 343 may move to the third deionization channel 373.

By charging the second side of the fourth current collector 314 with a negative potential, anions adsorbed onto the sixth porous electrode 326 may be desorbed from the sixth porous electrode 326, and by applying a negative voltage to the second current collector 312, cations adsorbed onto the second porous electrode 322 may be desorbed from the second porous electrode 322.

While a voltage is applied to the deionization device 300, the water treatment apparatus 2 according to an embodiment of the disclosure may efficiently remove divalent cations contained in raw water through the first electrode 301, the second electrode 302, the third electrode 303, and/or the fourth electrode 304, thereby softening the water.

In an embodiment, the deionization device 300 may include a device inlet 381 through which a fluid is received, and a device outlet 382 through which a fluid is discharged. A fluid flowed into the deionization device 300 through the device inlet 381 may pass through the first deionization channel 371, the second deionization channel 372, and/or the third deionization channel 373. The fluid passed through the first deionization channel 371, the second deionization channel 372, and/or the third deionization channel 373 may be discharged to outside of the deionization device 300 through the device outlet 382.

The water treatment apparatus 2 according to an embodiment may include a housing 380 having the device inlet 381 through which water is received and the device outlet 382 through which deionized water resulting from removing hardness components from the received water or wastewater with hardness components dissolved in the received water is discharged.

In an embodiment, the housing 380 may include the device inlet 381 through which water is flowed into the first deionization channel 371, the second deionization channel 372, and/or the third deionization channel 373, and the device outlet 382 through which deionized water or wastewater in the first deionization channel 371, the second deionization channel 372, and/or the third deionization channel 373 is discharged.

Water may be flowed from the outside of the deionization device 300 into the first deionization channel 371, the second deionization channel 372, and/or the third deionization channel 373 through the device inlet 381. Water in the first deionization channel 371, the second deionization channel 372, and/or the third deionization channel 373 may be discharged to the outside of the deionization device 300 through the device outlet 382.

The water treatment apparatus 2 according to an embodiment may include a flow regulator 400. For example, the flow regulator 400 may be installed in the housing 380. The flow regulator 400 may regulate a flow rate of a fluid flowing into the deionization channels, such as the first deionization channel 371, the second deionization channel 372, and the third deionization channel 373, of the deionization device 300. The flow regulator 400 may regulate the number of deionization channels into which a fluid flows among the plurality of deionization channels, such as the first deionization channel 371, the second deionization channel 372, and the third deionization channel 373, based on a flow rate of a fluid received through the device inlet 381. For example, the flow regulator 400 may increase the number of deionization channels into which a fluid flows among the plurality of deionization channels, such as the first deionization channel 371, the second deionization channel 372, and the third deionization channel 373, based on an increase of a flow rate of a fluid received through the device inlet 381.

The housing 380 may include a first guide flow path 391 for guiding a fluid received through the device inlet 381 to the first deionization channel 371, a second guide flow path 392 for guiding the fluid to the second deionization channel 372, and a third guide flow path 393 for guiding the fluid to the third deionization channel 373.

The flow regulator 400 may guide a fluid received through the device inlet 381 to the first guide flow path 391, the second guide flow path 392, and the third guide flow path 393. The flow regulator 400 may include a regulation body 410, and a rotation support 420 that supports a rotation of the regulation body 410. One end of the regulation body 410 may be rotatably coupled to the rotation support 420. The flow regulator 400 may include an elastic body for applying an elastic force to the regulation body 410 in a direction in which the first guide flow path 391, the second guide flow path 392, and the third guide flow path 393 are closed. The elastic body may be provided in the rotation support 420.

Referring to FIG. 11, the flow regulator 400 may block a part to which the flow paths are connected to prevent a fluid received through the device inlet 381 from flowing into the first guide flow path 391, the second guide flow path 392, and the third guide flow path 393.

Referring to FIG. 12, the flow regulator 400 may be positioned to close the first guide flow path 391 and the second guide flow path 392 to allow a fluid received through the device inlet 381 to flow into the third guide flow path 393 while blocking the fluid from flowing into the first guide flow path 391 and the second guide flow path 392. According to pressure of a fluid received through the device inlet 381 being first pressure which is relatively low, the regulation body 410 of the flow regulator 400 may move between an inlet of the third guide flow path 393 and an inlet of the second guide flow path 392. According to a flow rate of a fluid received through the device inlet 381 being a first flow rate which is relatively small, the regulation body 410 of the flow regulator 400 may move between an inlet of the third guide flow path 393 and the inlet of the second guide flow path 392.

Referring to FIG. 13, the flow regulator 400 may be positioned to close the first guide flow path 391 to allow a fluid received through the device inlet 381 to flow into the third guide flow path 393 and the second guide flow path 392 while blocking the fluid from flowing into the first guide flow path 391. According to pressure of a fluid received through the device inlet 381 being second pressure which is relatively medium, the regulation body 410 of the flow regulator 400 may move between the inlet of the second guide flow path 392 and the inlet of the first guide flow path 391. According to a flow rate of a fluid received through the device inlet 381 being a second flow rate which is relatively medium, the regulation body 410 of the flow regulator 400 may move between the inlet of the second guide flow path 392 and the inlet of the first guide flow path 391.

Referring to FIG. 14, the flow regulator 400 may be positioned to allow a fluid received through the device inlet 381 to flow into the third guide flow path 393, the second guide flow path 392, and the first guide flow path 391. According to pressure of a fluid received through the device inlet 381 being third pressure which is relatively high, the regulation body 410 of the flow regulator 400 may move to a position of opening the first guide flow path 391. According to a flow rate of a fluid received through the device inlet 381 being a third flow rate which is relatively large, the regulation body 410 of the flow regulator 400 may move to a position of opening the first guide flow path 391.

For example, based on an increase of a flow rate of a fluid received through the device inlet 381, the flow regulator 400 may sequentially open the third deionization channel 373 and the second deionization channel 372. Based on an increase of a flow rate of a fluid received through the device inlet 381, the flow regulator 400 may sequentially open the third deionization channel 373, the second deionization channel 372, and the first deionization channel 371.

Because any of the water treatment apparatus 1 and the water treatment apparatus 2 according to various embodiments of the disclosure responds to various flow rates, the any of the water treatment apparatus 1 and the water treatment apparatus 2 may be applied to various home appliances requiring different flow rates. Hereinafter, for convenience of description, an embodiment to which the water treatment apparatus 1 shown in FIG. 1, FIG. 2, FIG. 3, FIG. 4, FIG. 5, FIG. 6, FIG. 7, FIG. 8, FIG. 9, and FIG. 10 is applied will be described. However, the disclosure is not limited thereto, and the water treatment apparatus 2 shown in FIG. 11, FIG. 12, FIG. 13, and FIG. 14, instead of the water treatment apparatus 1 shown in FIG. 1, FIG. 2, FIG. 3, FIG. 4, FIG. 5, FIG. 6, FIG. 7, FIG. 8, FIG. 9, and FIG. 10, may be applied.

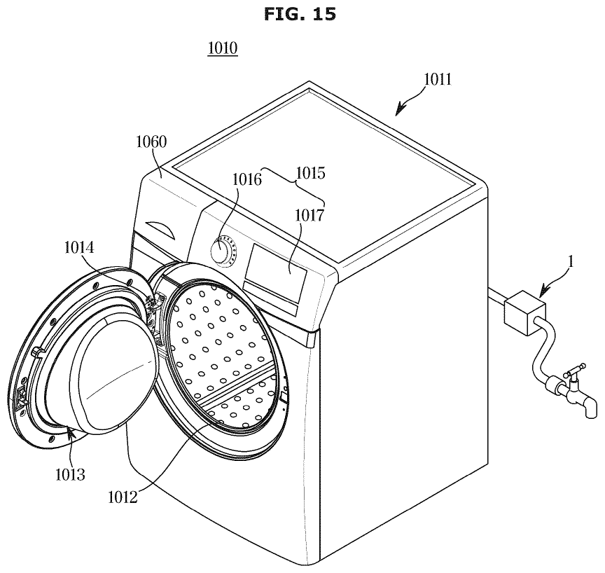

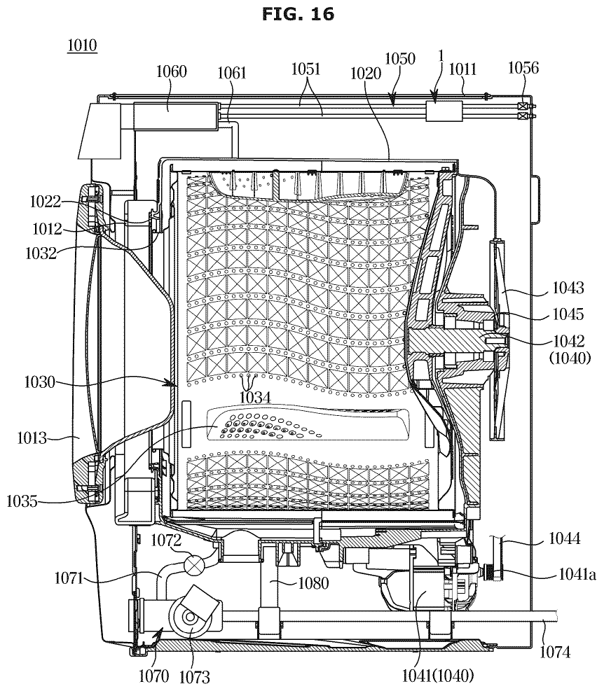

FIG. 15 shows a washing machine to which a water treatment apparatus according to an embodiment of the disclosure is connected. FIG. 16 shows a cross section of a washing machine to which a water treatment apparatus according to an embodiment of the disclosure is connected.

Referring to FIG. 15 and FIG. 16, a washing machine 1010 to which the water treatment apparatus 1 according to an embodiment of the disclosure is applied will be described.

The washing machine 1010 may include a washing machine housing 1011 that accommodates various components therein. The washing machine housing 1011 may form an outer appearance of the washing machine 1010. The washing machine housing 1011 may have a box shape of which a portion opens.

The washing machine housing 1011 may include a housing opening 1012 that allows an access to inside of a drum 1030. The housing opening 1012 may open substantially toward a front direction.

The washing machine 1010 may include a door 1013 for opening or closing the housing opening 1012 provided in the washing machine housing 1011. The door 1013 may be rotatably installed on the washing machine housing 1011 by a hinge 1014. At least a portion of the door 1013 may be transparent or translucent to show inside of the washing machine housing 1011.

The washing machine 1010 may include a tub 1020 provided inside the washing machine housing 1011 to store water. The tub 1020 may be positioned inside the washing machine housing 1011. The tub 1020 may include a tub opening 1022 corresponding to the housing opening 1012. The tub opening 1022 may open substantially toward the front direction. The tub 1020 may be supported on an inner side of the washing machine housing 1011. The tub 1020 may have a substantially cylindrical shape of which one side opens.

The tub 1020 may be elastically supported from the washing machine housing 1011 by a damper 1080. The damper 1080 may connect the tub 1020 to the washing machine housing 1011. While vibrations generated according to a rotation of the drum 1030 are transferred to the tub 1020 and/or the washing machine housing 1011, the damper 1080 may absorb vibration energy between the tub 1020 and the washing machine housing 1011 to attenuate the vibrations.

The washing machine 1010 may include a drum 1030 to accommodate laundry. The drum 1030 may be rotatably provided inside the tub 1020. The drum 1030 may perform washing, rinsing, and/or dehydrating while rotating inside the tub 1020. The drum 1030 may include a through hole 1034 that connects an inside space of the drum 1030 to an inside space of the tub 1020. The drum 1030 may have a substantially cylindrical shape of which one side opens. On an inner circumferential surface of the drum 1030, at least one lifter 1035 may be provided to raise and drop laundry according to a rotation of the drum 1030.

The drum 1030 may include a drum opening 1032 corresponding to the housing opening 1012 and the tub opening 1022. Laundry may be put into or withdrawn from the drum 1030 through the housing opening 1012, the tub opening 1022, and the drum opening 1032.

The washing machine 1010 may include a washing machine driver 1040 configured to rotate the drum 1030. The washing machine driver 1040 may include a driving motor 1041, and a rotating shaft 1042 for transferring a driving force generated in the driving motor 1041 to the drum 1030. The rotating shaft 1042 may be connected to the drum 1030 by penetrating the tub 1020.

The washing machine 1010 may be classified into a direct driving type in which the rotating shaft 1042 is connected directly to the driving motor 1041 to rotate the drum 1030, and an indirect driving type in which a pulley 1043 is connected between the driving motor 1041 and the rotating shaft 1042 to drive the drum 1030.

The washing machine 1010 according to an embodiment may be provided as an indirect driving type, although not limited thereto. However, the washing machine 1010 may be provided as a direct driving type.

One end of the rotating shaft 1042 may be connected to the drum 1030, and another end may be connected to the pulley 1043 to receive power from the driving motor 1041. On a rotation axis of the driving motor 1041, a motor pulley 1041a may be formed. A driving belt 1044 may be provided between the motor pulley 1041a and the pulley 1043 such that the rotating shaft 1042 is driven by the driving belt 1044.

In a rear portion of the tub 1020, a bearing housing 1045 may be installed to rotatably support the rotating shaft 1042. The bearing housing 1045 may be made of an aluminum alloy. The bearing housing 45 may be inserted into the rear portion of the tub 1020 during injection-molding of the tub 1020.

The washing machine driver 1040 may rotate the drum 1030 forward or backward to perform a washing operation, a rinsing operation, and/or a dehydrating operation or a drying operation.

The washing machine 1010 may include a water supply device 1050. The water supply device 1050 may supply water to the tub 1020. The water supply device 1050 may be positioned above the tub 1020. The water supply device 1050 may include a water supply tube 1051, and a water supply valve 1056 provided in the water supply tube 1051. The water supply tube 1051 may be connected to an external water supply source. The water supply tube 1051 may extend to a detergent supply device 1060 and/or the tub 1020 from the external water supply source. Water may be supplied to the tub 1020 via the detergent supply device 1060. Water may be supplied to the tub 1020 not via the detergent supply device 1060.

The water supply valve 1056 may open or close the water supply tube 1051 in response to an electrical signal from a controller. The water supply valve 1056 may allow or block supply of water from the external water supply source to the tub 1020. The water supply valve 1056 may include, for example, a solenoid valve that is opened or closed in response to an electrical signal.

The washing machine 1010 may include the detergent supply device 1060 configured to supply a detergent to the tub 1020. The detergent supply device 1060 may supply a detergent to the inside of the tub 1020 during a water supply process. Water supplied through the water supply tube 1051 may be mixed with a detergent via the detergent supply device 1060. The water mixed with the detergent may be supplied to the inside of the tub 1020. The detergent may include a conditioner for dryer, a deodorant, a sterilizer, or an air freshener, as well as a washing detergent. The detergent supply device 1060 may be connected to the tub 1020 through a connecting tube 1061.

The washing machine 1010 may include a drain device 1070. The drain device 1070 may discharge water accommodated in the tub 1020 to outside. The drain device 1070 may include a drain pump 1073 for discharging water accommodated in the tub 1020 to outside of the washing machine housing 1011, a connecting hose 1071 connecting the drain pump 1073 to the tub 1020 such that water stored in the tub 1020 flows to the drain pump 1073, and a drain hose 1074 for guiding water pumped by the drain pump 1073 to the outside of the washing machine housing 1011. The drain device 1070 may include a drain valve 1072 provided in the connecting hose 1071 to open or close the connecting hose 1071.

The washing machine 1010 may provide a user interface 1015 for interactions with a user.

The washing machine 10 may include at least one user interface 1015. The user interface 1015 may include at least one input interface 1016 and/or at least one output interface 1017.

The at least one input interface 1016 may convert sensory information received from a user into an electrical signal.

The at least one input interface 1016 may include a power button, an operation button, a course selection dial (or a course selection button), and a washing/rinsing/dehydrating setting button. The at least one input interface 1016 may include, for example, a tact switch, a push switch, a slide switch, a toggle switch, a micro switch, a touch switch, a touch pad, a touch screen, a jog dial, and/or a microphone, etc.

The at least one output interface 1017 may generate sensory information and transfer various data related to an operation of the washing machine 1010 to a user.

For example, the at least one output interface 1017 may transfer information related to a washing course, an operation time of the washing machine 1010 and a washing setting/rinsing setting/dehydrating setting to a user. Information related to an operation of the washing machine 1010 may be output through a screen, an indicator, a voice, etc. The at least one output interface 1017 may include, for example, a Liquid Crystal Display (LCD) panel, a Light Emitting Diode (LED) panel, a speaker, etc.

The water treatment apparatus 1 or 2 according to various embodiments may remove ions from water that is supplied to the washing machine 1010. In FIG. 15 and FIG. 16, the water treatment apparatus 1 of FIG. 1 is shown as being provided for the washing machine 1010. However, the water treatment apparatus 2 shown in FIG. 11, FIG. 12, FIG. 13, and FIG. 14 may be provided for the washing machine 1010.

For example, the washing machine 1 may be, as shown in FIG. 15, positioned outside the washing machine 1010. The water treatment apparatus 1 may be positioned outside the washing machine 1010 and configured to remove ions from water that is supplied to the washing machine 1010. The water treatment apparatus 1 may be provided on a flow path that connects an external water supply source and the washing machine 1010.

For example, the water treatment apparatus 1 may be, as shown in FIG. 16, positioned inside the washing machine 1010. The water treatment apparatus 1 may be connected to a water supply pipe 1051. The water treatment apparatus 1 may be configured to remove ions from water passing through the water supply pipe 1051. A position of the water treatment apparatus 1 is not limited to the water supply pipe 1051, and the water treatment apparatus 1 may be provided at various locations through which water to be supplied to the washing machine 1010 passes.

The water treatment apparatus 1 according to various embodiments may be positioned outside and/or inside the washing machine 1010.

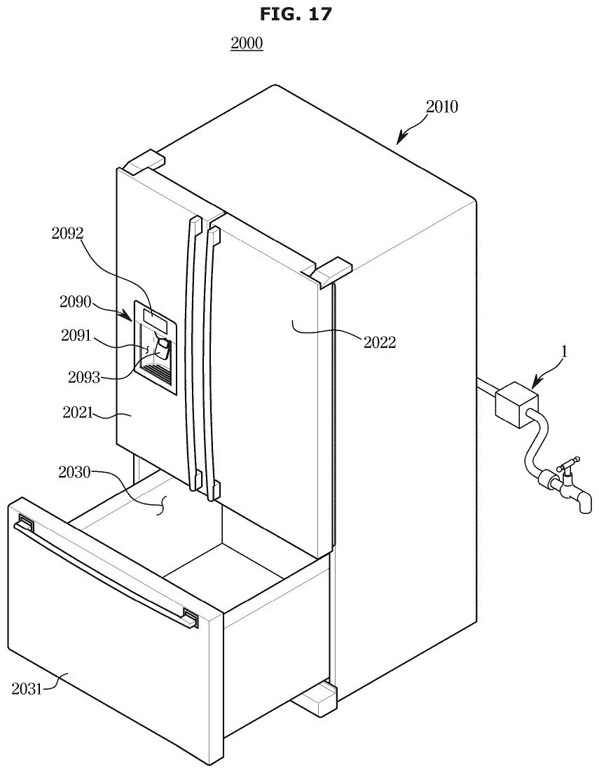

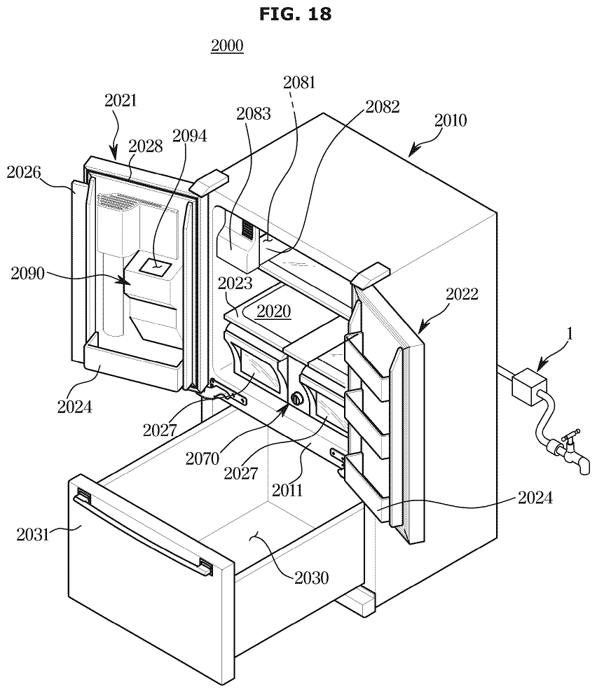

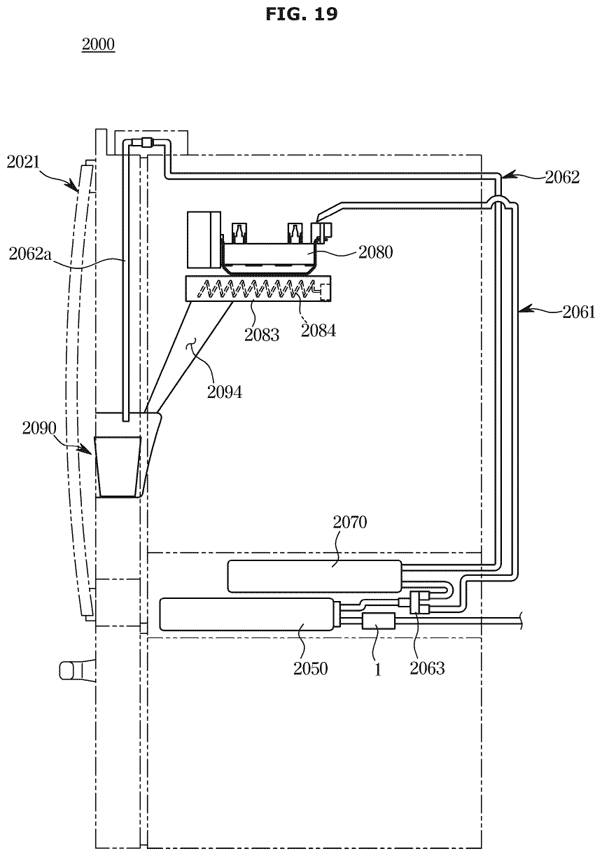

FIG. 17 shows a refrigerator to which a water treatment apparatus according to an embodiment of the disclosure is connected. FIG. 18 shows a state in which doors of a refrigerator to which a water treatment apparatus according to an embodiment of the disclosure is connected open. FIG. 19 shows a cross section of a refrigerator to which a water treatment apparatus according to an embodiment of the disclosure is applied.

A refrigerator 2000 to which the water treatment apparatus 1 according to an embodiment of the disclosure is connected and/or applied will be described with reference to FIG. 17, FIG. 18, and FIG. 19.

The refrigerator 2000 according to an embodiment may include a main body 2010.

The main body 2010 may include an inner case, an outer case positioned outside the inner case, and an insulation provided between the inner case and the outer case.

The inner case may include at least one of a case, a plate, a panel or a liner forming any of a storage room 2020 and a storage room 2030. The inner case may be formed as one body or may be formed by assembling a plurality of plates together. The outer case may form an outer appearance of the main body and may be coupled to an outer side of the inner case, wherein the insulation is positioned between the inner case and the outer case.

The insulation may insulate inside of the any of the storage room 2020 and the storage room 2030 from outside of the any of the storage room 2020 and the storage room 2030 such that internal temperature of the any of the storage room 2020 and the storage room 2030 is maintained at preset appropriate temperature without being influenced by an external environment of the storage room 2020 or 2030. According to an embodiment, the insulation may include a foaming insulation. The foaming insulation may be molded by injecting urethane foam as a mixture of polyurethane and a foaming agent between the inner case and the outer case and foaming the urethane foam.

According to an embodiment, the insulation may further include a vacuum insulation, in addition to a foaming insulation, or the insulation may be configured only with a vacuum insulation, instead of a foaming insulation. The vacuum insulation may include a core material, and a cladding material accommodating the core material therein and sealing inside with vacuum or pressure close to vacuum. However, the insulation is not limited to a foaming insulation or a vacuum insulation mentioned above and may include various materials capable of being used for insulation.

The any of the storage room 2020 and the storage room 2030 may include a space defined by the inner case. The any of the storage room 2020 and the storage room 2030 may further include an inner case defining a space corresponding to the any of the storage room 2020 and the storage room 2030. Various goods, such as food, medicine, cosmetics, etc., may be stored in the any of the storage room 2020 and the storage room 2030, and at least one side of the any of the storage room 2020 and the storage room 2030 may open to put the goods in or take the goods out.

The refrigerator 2000 may include one or more storage rooms 2020 and 2030. In the case in which two or more storage rooms 2020 and 2030 are formed in the refrigerator 2000, the respective storage rooms 2020 and 2030 may have different purposes of use and may be maintained at different temperature. To this end, the storage room 2020 and the storage room 2030 may be partitioned from each other by a partition wall 11 including an insulation.

The storage room 2020 and the storage room 2030 may be maintained within appropriate temperature ranges according to the purposes of use, and may include a refrigerating room, a freezing room, and a temperature conversion room that are divided according to the purposes of use and/or the temperature ranges. The refrigerating room may be maintained at a temperature suitable for keeping goods refrigerated and the freezing room may be maintained at a temperature suitable for keeping goods frozen. Refrigerating may mean cooling goods in a range in which the goods are not frozen, and for example, the refrigerating room may be maintained within a range of 0° C. to 7° C. above zero. Freezing may mean freezing goods or cooling goods to keep the goods frozen, and for example, the freezing room may be maintained in a range of 1° C. to 20° C. below zero. The temperature conversion room may be used as any one of a refrigerating room or a freezing room according to a user's selection or regardless of a user's selection.

The storage room 2020 and the storage room 2030 may be also called various other terms, such as vegetable room, freshness room, cooling room, and ice-making room, in addition to refrigerating room, freezing room, and temperature conversion room, and the terms, such as refrigerating room, freezing room, temperature conversion room, etc., as used below need to be understood to represent the storage room 2020 and the storage room 2030 having the corresponding purposes of use and the corresponding temperature ranges.

Inside the storage room 2020 and the storage room 2030, a shelf 2023 on which food is put and at least one storage container 2027 for storing food may be provided.

According to an embodiment, the refrigerator 2000 may include one or more doors, such as a door 2021, a door 2022, and a door 2031, configured to open or close open sides of the storage room 2020 and the storage room 2030. The first door 2021, the second door 2022, and the third door 2031 may be provided to open or close one or more storage rooms 2020 and 2030 independently, or one of the first door 2021, the second door 2022, and the third door 2031 may be provided to open or close a plurality of storage rooms 2020 and 2030. The first door 2021, the second door 2022, and the third door 2031 may be rotatably or slidably mounted on a front surface of the main body 2010.

The first door 2021, the second door 2022, and the third door 2031 may seal the storage room 2020 and the storage room 2030 in a closed state. The first door 2021, the second door 2022, and the third door 2031 may include an insulation, like the main body 2010, to insulate the storage room 2020 and the storage room 2030 in the closed state.

According to an embodiment, the first door 2021, the second door 2022, and the third door 2031 may include door outer plates forming front surfaces of the first door 2021, the second door 2022, and the third door 2031, door inner plates forming rear surfaces of the first door 2021, the second door 2022, and the third door 2031 and facing the storage room 2020 and the storage room 2030, upper caps, lower caps, and door insulations provided thereinside.

On edges of the door inner plates, a gasket 2028 that is tightly pressed against the front surface of the main body 2010 when the first door 2021, the second door 2022, and the third door 2031 are closed to seal up the storage room 2020 and the storage room 2030 may be provided. Each door inner plate may include a dyke 2025 protruding in a rear direction to install a door basket 2024 for storing goods thereon.

According to an embodiment, in the case in which two doors, the first door 2021 and the second door 2022, open or close one storage room 2020, the refrigerator 2000 may include a rotating bar 2026 that seals between the two doors, the first door 2021 and the second door 2022, to prevent cool air in the storage room 2020 from leaking out.

According to an embodiment, each of the first door 2021, the second door 2022, and the third door 2031 may include a door body, and a front panel detachably coupled to a front side of the door body and forming a front surface of the door. The door body may include a door outer plate forming a front surface of the door body, a door inner plate forming a rear surface of the door body and facing a storage room, an upper cap, a lower cap, and a door insulation provided thereinside.

The refrigerator 2000 may be classified into a French Door Type, a Side-by-Side type, a Bottom Mounted Freezer, a Top Mounted Freezer, a one-door refrigerator, etc., according to positions of the first door 2021, the second door 2022, and the third door 2031 and the storage room 2020 and the storage room 2030.

According to an embodiment, the refrigerator 2000 may include a cool air supply device for supplying cool air to the storage room 2020 and the storage room 2030.

The cool air supply device may include a machine, an apparatus, an electronic device, and/or a combination system thereof, capable of generating cool air and guiding the cool air to cool the storage room 2020 and the storage room 2030.

According to an embodiment, the cool air supply device may generate cool air through a cooling cycle including compression, condensation, expansion, and evaporation processes of refrigerants. To this end, the cool air supply device may include a cooling cycle device having a compressor, a condenser, an expander, and an evaporator to operate the cooling cycle. According to an embodiment of the disclosure, the cool air supply device may include a semiconductor such as a thermoelectric element. The thermoelectric element may cool the storage room 2020 and the storage room 2030 by heating and cooling actions through the Peltier effect.

According to an embodiment, the refrigerator 2000 may include a machine room where at least some components belonging to the cool air supply device are installed.

The machine room may be partitioned and insulated from the storage room 2020 and the storage room 2030 to prevent heat generated from the components installed in the machine room from being transferred to the storage room 2020 and the storage room 2030. To dissipate heat from the components installed inside the machine room, the machine room may communicate with outside of the main body 2010.

According to an embodiment of the disclosure, the refrigerator 2000 may include a dispenser 2090 installed in at least any door 2021 to provide water and/or ice. The dispenser 2090 may be installed in the door 2021 to allow a user to access the dispenser 2090 without opening the door 2021.

The dispenser 2090 may include a water intake space 2091 for enabling a user to place a container therein and receive water or ice, and an operating lever 2093 for operating the dispenser 2090 to discharge water or ice.

According to an embodiment, the refrigerator 2000 may include an ice maker 2080 for forming ice. The ice maker 2080 may include an ice making tray storing water, an ice transfer device for separating ice from the ice making tray, and an ice bucket 2083 storing ice formed in the ice making tray.

The ice maker 2080 may be positioned at an ice making room 2081 provided in an upper corner of any storage room 2020. The ice making room 2081 may be partitioned from the storage room 2020 by an ice making room wall 2082. An auger 2084 may be provided in the ice making room 2081 to transport ice stored in the ice bucket 2083 to a chute 2094.

According to an embodiment, the refrigerator 2000 may include a water tank 2070 that stores water. The water tank 2070 may be connected to an external water supply source. The water tank 2070 may store water purified through a purifying filter 2050. On a water supply line that connects the external water supply source to the water tank 2070, a valve 2063 may be provided.

According to an embodiment, the refrigerator 2000 may include an ice making water supply flow path 2061 for supplying water to the ice maker 2080, and a dispenser water supply flow path 2062 for supplying water to the dispenser 2090.

According to an embodiment, the refrigerator 2000 may include a controller for controlling the refrigerator 2000.

The controller may process a user input received through a user interface 2092 and control operations of the user interface 2092. The user interface 2092 may include an input interface and an output interface. The controller may receive a user input from the user interface 2092. Also, the controller may transfer, in response to a user input, image data and a display control signal for displaying an image on the user interface 2092 to the user interface 2092.

The input interface may include a key, a touch screen, a microphone, etc. The input interface may receive a user input and transfer the user input to a processor.

The output interface may include a display, a speaker, etc. The output interface may output various notifications, messages, information, etc. generated by the processor.

Any of the water treatment apparatus 1 and the water treatment apparatus 2 according to various embodiments may remove ions from water that is supplied to the refrigerator 2000. In FIG. 17, FIG. 18, and FIG. 19, the water treatment apparatus 1 of FIG. 1 is shown as being provided for the refrigerator 2000. However, the refrigerator 2000 shown in FIG. 11, FIG. 12, FIG. 13, and FIG. 14 may be provided for the refrigerator 2000.

The water treatment apparatus 1 according to various embodiments may be positioned outside and/or inside the refrigerator 2000.

For example, the water treatment apparatus 1 may be positioned outside the refrigerator 2000, as shown in FIG. 17 and FIG. 18. The water treatment apparatus 1 may be positioned outside the refrigerator 2000 and configured to remove ions from water that is supplied to the refrigerator 2000. The water treatment apparatus 1 may be provided on a flow path that connects an external water supply source and the refrigerator 2000.

For example, the water treatment apparatus 1 may be positioned inside the refrigerator 2000, as shown in FIG. 19. The water treatment apparatus 1 may be connected to a water supply line. The water treatment apparatus 1 may remove ions from water passing through the water supply line. A position of the water treatment apparatus 1 is not limited to the water supply line and may be positioned at various locations through which water to be supplied to the refrigerator 2000 passes.

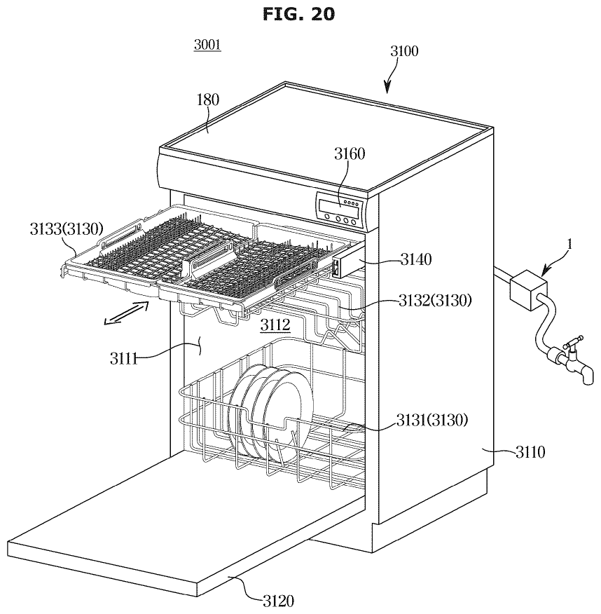

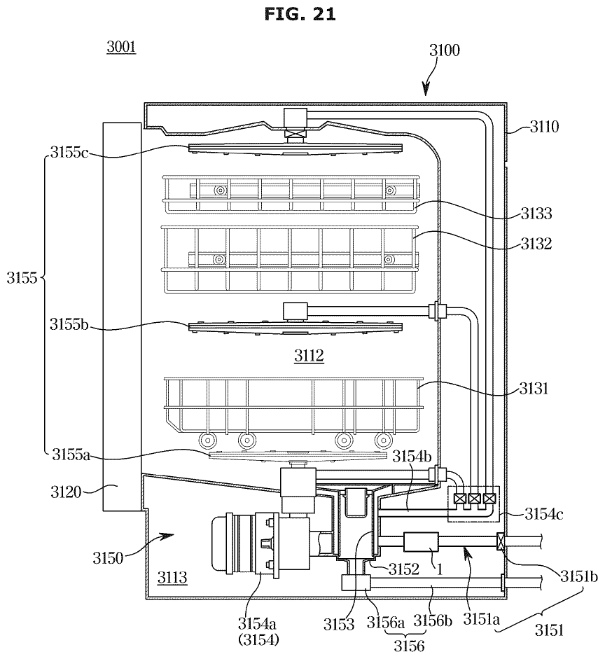

FIG. 20 shows a dishwasher to which a water treatment apparatus according to an embodiment of the disclosure is connected. FIG. 21 shows a cross section of a dishwasher to which a water treatment apparatus according to an embodiment of the disclosure is applied.

A dishwasher 3100 to which the water treatment apparatus 1 according to an embodiment of the disclosure is connected and/or applied will be described with reference to FIG. 20 and FIG. 21.

The dishwasher 3100 may include a main body 3110, a door 3120, a storage portion 3130, a sliding member 3140, a washing assembly 3150, and a user interface 3160.

The main body 3110 may form an outer appearance of the dishwasher 3100. In one side of the main body 3110, an opening 3111 may be formed, and a washing tub 3112 that is opened or closed by a door 3120 and a machine room 3113 spatially separated from the washing tub 3112 may be provided inside the main body 3110.

The door 3120 may be rotatable on the main body 3110 to open or close the opening 3111 of the main body 3110. The door 3120 may be hinge-coupled to a lower part of the main body 3110. A handle or a groove for a handle may be formed on an outer side of the door 3120 to allow a user to manually open the door 3120.

The storage portion 3130 may include a first basket 3131 and a second basket 3132 and a cutlery 3133 that are spaced apart from each other inside the washing tub 3112, slide back and forth, have holes of various sizes, and store dishes, etc. therein.

The first basket 3131 may accommodate various tableware, such as bowls, plates, and cooking tools, to be washed, the second basket 3132 may accommodate cups, etc., and the cutlery 3133 may accommodate forks, table knives, spoons or chopsticks, cutlery, ladles, etc.

The sliding member 3140 may be provided in the washing tub 3112 and slide to guide movements of the first basket 3131 and the second basket 3132 and cutlery 3133.

The washing assembly 3150 may include a water supply 3151, a sump 3152, a heater 3153, a circulation portion 3154, a nozzle portion 3155, and a drain 3156, which are provided in the machine room 3113 and the washing tub 3112 and perform a washing operation, a rinsing operation, a drying operation, etc.

The water supply 3151 may include a water supply pipe 3151a positioned between an external water supply source and the sump 3152 to guide water received from outside to the sump 3152, and a water supply valve 3151b that blocks supply of water from the outside.

The sump 3152 may store water received through the water supply pipe 3151a. The water may become washing water with detergent dissolved therein and the washing water may circulate through the washing tub 3112, the sump 3152, the circulation portion 3154, and the nozzle portion 3155.

The heater 3153 may be positioned around the sump 3152 and heat washing water in the sump 3152.

Also, a temperature detector for detecting temperature of water may be further provided in the sump 3152.

The circulation portion 3154 may be positioned between the sump 3152 and the nozzle portion 3155 to pump washing water in the sump 3152 and supply the washing water to the nozzle portion 3155 through a circulation pipe 3154b.

The circulation portion 3154 may include a circulation pump 3154a for pumping washing water in the sump 3152, a plurality of circulation pipes 3154b for guiding the pumped washing water to the nozzle portion 3155, and a valve 3154c provided in each of the circulation pipes 3154b to control circulation of the pumped washing water.

The nozzle portion 3155 may spray washing water supplied through the circulation portion 3154 toward various dishes accommodated in the first basket 3131 and the second basket 3132 and the cutlery 3133.

The nozzle portion 3155 may include a first nozzle 3155a provided below the first basket 3131, a second nozzle 3155b provided between the first basket 3131 and the second basket 3132, and a third nozzle 3155c provided above the cutlery 3133. The first, second, and third nozzles 3155a, 3155b, and 3155c may be rotated by a rotor.

The drain 3156 may discharge washing water in the sump 3152 to the outside.

The drain 3156 may include a drain pump 3156a for pumping washing water in the sump 3152, and a drain pipe 3156b for guiding pumped washing water to the outside. Also, the drain 3156 may further include a drain valve that controls discharging of washing water in the sump 3152 to the outside.

The user interface 3160 may be provided in the main body 3110 and control and display operation information of the dishwasher.

The user interface 3160 may receive various washing courses (for example, a standard course, a manual course, etc.) and operation information such as additional rinsing according to a user's command, display information on an operation in progress, and display error information when an error occurs.

Here, the washing courses may include a washing operation of washing dishes by spraying washing water onto the dishes, a rinsing operation of rinsing the dishes by spraying rinsing water onto the dishes, and a drying operation of drying the dishes after rinsing.

Any of the water treatment apparatus 1 and the water treatment apparatus 2 according to various embodiments may remove ions from water that is supplied to the dishwasher 3100. In FIG. 20 and FIG. 21, the water treatment apparatus 1 of FIG. 1 is shown as being provided for the dishwasher 3100. However, the water treatment apparatus 1 shown in FIG. 11, FIG. 12, FIG. 13, and FIG. 14 may be provided for the dishwasher 3100.

The water treatment apparatus 1 according to various embodiments may be positioned outside and/or inside the dishwasher 3100.

For example, the water treatment apparatus 1 may be positioned outside the dishwasher 3100, as shown in FIG. 20. The water treatment apparatus 1 may be positioned outside the dishwasher 3100 to remove ions from water that is supplied to the dishwasher 3100. The water treatment apparatus 1 may be provided on a flow path that connects an external water supply source and the dishwasher 3100.

For example, the water treatment apparatus 1 may be positioned inside the dishwasher 3100, as shown in FIG. 21. The water treatment apparatus 1 may be connected to the water supply pipe 3151a. The water treatment apparatus 1 may remove ions from water passing through the water supply pipe 3151a. A position of the water treatment apparatus 1 is not limited to the water supply pipe 3151a and may be positioned at various locations through which water to be supplied to the dishwasher 3100 passes.

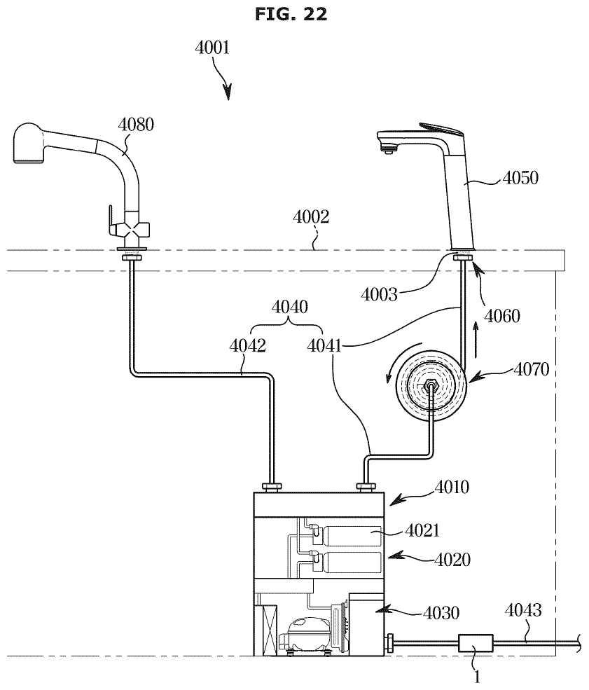

FIG. 22 shows a water purifier to which a water treatment apparatus according to an embodiment of the disclosure is applied.

A water purifier 4000 according to an embodiment of the disclosure will be described with reference to FIG. 22. The water purifier 4000 shown in FIG. 22 may include one of the water treatment apparatus 1 and the water treatment apparatus 2 shown in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, and FIG. 14. For example, the water purifier 4000 may include the water treatment apparatus 1 shown in FIG. 1.

Referring to FIG. 22, the water purifier 4000 may include a purifier body 4010, and a dispenser 4050 connected to the purifier body 4010 to discharge a liquid to outside of the purifier body 4010. The purifier body 4010 may be positioned below a kitchen worktop 4002, and the dispenser 4050 may be positioned on the kitchen worktop 4002. The kitchen worktop 4002 may include a kitchen sink. The kitchen sink may include a sink and a kitchen countertop.

The dispenser 4050 may be rotatably installed on the kitchen worktop 4002. For example, the dispenser 4050 may be rotatably installed on the kitchen sink. The dispenser 4050 may be connected to the purifier body 4010 through a connecting tube 4040.

The purifier body 4010 may be positioned inside the kitchen worktop 4002. The purifier body 4010 may include a filter unit 4020 including at least one filter 4021, and a heat exchange unit 4030 configured to cool or heat a liquid purified by the filter unit 4020. The heat exchange unit 4030 may include a cooler and a heater.

The purifier body 4010 may receive raw water such as tap water through an external pipe 4043.

The connecting tube 4040 of the purifier body 4010 may include a first tube 4041 connecting the purifier body 4010 to the dispenser 4050, and a second tube 4042 connecting the purifier body 4010 to a faucet 4080 mounted on the kitchen worktop 4002.

An installation member 4003 for installing the dispenser 4050 may be provided in the kitchen worktop 4002. The installation member 4003 may be formed by opening at least a portion of the kitchen worktop 4002. The dispenser 4050 may be connected to the first tube 4041 through the installation member 4003 of the kitchen worktop 4002.

The dispenser 4050 may be rotatably installed on the installation member 4003. The water purifier 4000 may include a rotation member 4060 for rotatably installing the dispenser 4050 on the installation member 4003. The rotation member 4060 may be coupled to the kitchen worktop 4002.

The water purifier 4000 may include a pipe fixing member 4070 that fixes the first tube 4041 and the second tube 4042. The pipe fixing member 4070 may be positioned inside the kitchen worktop 4002. The pipe fixing member 4070 may be positioned between the purifier body 4010 and the dispenser 4050. The pipe fixing member 4070 may be fixed to any one of the purifier body 4010 or the kitchen worktop 4002. Some parts of the first tube 4041 and the second tube 4042 may be wound around the pipe fixing member 4070, and by winding/releasing some parts of the first tube 4041 and the second tube 4042 around/from the pipe fixing member 4070, lengths of the first tube 4041 and the second tube 4042 may be extended or shortened.

The water purifier 4000 according to an embodiment may include the water treatment apparatus 1. The water treatment apparatus 1 may be connected to an external pipe 4043. The water treatment apparatus 1 may remove ions from water passing through the external pipe 4043. A position of the water treatment apparatus 1 is not limited to the external pipe 4043, and may be positioned at various locations through which water to be supplied to the water purifier 4000 passes.

A water treatment apparatus according to an embodiment includes a housing including a device inlet and a device outlet, a deionization device including a plurality of electrodes and a plurality of deionization channels configured to be formed between the plurality of electrodes to pass a fluid introduced through the device inlet to the plurality of deionization channels, and a flow regulator configured to, based on a flow rate of the fluid introduced through the device inlet, regulate a number of deionization channels into which the fluid flows among the plurality of deionization channels.

The flow regulator may be further configured to, based on an increase of the flow rate of the fluid introduced through the device inlet, increase the number of deionization channels into which the fluid flows among the plurality of deionization channels.

The plurality of deionization channels may include a first deionization channel and a second deionization channel having a deionization performance that is higher than a deionization performance of the first deionization channel.

The flow regulator may be further configured to, based on an increase of the flow rate of the fluid introduced through the device inlet, sequentially open the first deionization channel and the second deionization channel.

A first ion storage capacity of a first electrode, among the plurality of electrodes, forming the second deionization channel may be larger than a second ion storage capacity of a second electrode, among the plurality of electrodes, forming the first deionization channel.

A first gap of the first deionization channel may be smaller than a second gap of the second deionization channel.

The flow regulator may be further configured to regulate the number of deionization channels into which the fluid flows among the plurality of deionization channels, when the flow rate of the fluid introduced into the housing is a first flow rate, to be less than the number of deionization channels into which the fluid flows among the plurality of deionization channels, when the flow rate of the fluid introduced into the housing is a second flow rate that is greater than the first flow rate.

The plurality of deionization channels may include a first deionization channel and a second deionization channel. The plurality of electrodes may include a first electrode, an intermediate electrode spaced a first distance from the first electrode and forming the first deionization channel, and a second electrode spaced a second distance from the intermediate electrode and forming the second deionization channel, the second distance being greater than the first distance.

The flow regulator may include a regulation body configured to move based on the flow rate of the fluid introduced through the device inlet, a moving body configured to move based on a movement of the regulation body, and a pressing portion configured to move based on a movement of the moving body to open and close the plurality of deionization channels.

The plurality of electrodes may include a current collector including a material that is compressible and restorable by the pressing portion.

The regulation body may be further configured to move based on a difference between a first pressure of the fluid introduced through the device inlet and a second pressure of the fluid as discharged through the device outlet.

The regulation body may be further configured to, based on the first pressure of the fluid introduced through the device inlet being higher than the second pressure of the fluid discharged through the device outlet, move to increase a size of a deionization channel into which the fluid flows or increase the number of deionization channels into which the fluid flows among the plurality of deionization channels.

The pressing portion may be further configured to, according to the pressing portion opening at least a deionization channel of the plurality of deionization channels, move to regulate a size of an opening of the deionization channel.

The flow regulator may include an elastic body configured to apply an elastic force to the moving body in a first direction in which the pressing portion opens the plurality of deionization channels. The regulation body may include a body support supporting the moving body in a second direction in which the pressing portion closes the plurality of deionization channels.

The water treatment apparatus may further include a state display provided on the housing. The flow regulator may include a slider configured to move relative to the housing according to the movement of the regulation body, the slider being positioned at a preset location with respect to the state display based on the flow rate of the fluid introduced through the device inlet.

A water treatment apparatus according to an embodiment includes a housing including a device inlet and a device outlet, a first electrode, a second electrode, an intermediate electrode provided between the first electrode and the second electrode, a first deionization channel formed between the first electrode and the intermediate electrode, a second deionization channel formed between the second electrode and the intermediate electrode, and a flow regulator configured to open or close the first deionization channel and the second deionization channel based on a flow rate of a fluid flowing into the housing.

The flow regulator may be configured to, based on a flow rate of a fluid flowing into the housing being a first flow rate, open the first deionization channel to supply the fluid to the first deionization channel, and based on a flow rate of a fluid flowing into the housing being a second flow rate which is greater than the first flow rate, open the first deionization channel and the second deionization channel to supply the fluid to the first deionization channel and the second deionization channel.

While the first deionization channel and the second deionization channel open, a gap between the second electrode and the intermediate electrode may be larger than a gap between the first electrode and the intermediate electrode.

The flow regulator may be configured to, while the first deionization channel opens, regulate a size of the first deionization channel based on a pressure difference between a fluid received through the device inlet and a fluid discharged through the device outlet, and while the second deionization channel opens, regulate a size of the second deionization channel based on a pressure difference between a fluid received through the device inlet and a fluid discharged through the device outlet.

Deionization performance of the second deionization channel may be higher than that of the first deionization channel. Based on an increase of a flow rate of a fluid received through the device inlet, the flow regulator may sequentially open the first deionization channel and the second deionization channel.

According to an aspect of the disclosure, the water treatment apparatus may open or close the deionization channels based on a flow rate of a received fluid, thereby improving efficiency.

According to an aspect of the disclosure, the water treatment apparatus may regulate degrees of opening of the deionization channels based on a flow rate of a received fluid, thereby improving efficiency.

According to an aspect of the disclosure, upon formation of scale, the water treatment apparatus may display formation of scale for a user to check, thereby improving convenience of use.

According to an aspect of the present disclosure, the water treatment device may respond to various flow rates, thereby improving usability.

Effects that may be achieved according to the disclosure are not limited to the above-mentioned effects, and other effects not mentioned will be clearly understood by one of ordinary skill in the technical field to which the disclosure belongs from the following descriptions.

So far, specific embodiments have been shown and described. However, the disclosure is not limited to the above-described embodiments, and various modifications can be made by one of ordinary skill in the technical art to which the disclosure belongs without departing from the gist of the technical idea of the disclosure defined by the claims below.

What is claimed is:

1. A water treatment apparatus comprising:
a housing comprising a device inlet and a device outlet;
a deionization device comprising a plurality of electrodes and a plurality of deionization channels configured to be formed between the plurality of electrodes to pass a fluid introduced through the device inlet to the plurality of deionization channels; and
a flow regulator configured to, based on a flow rate of the fluid introduced through the device inlet, regulate a number of deionization channels into which the fluid flows among the plurality of deionization channels.

2. The water treatment apparatus of claim 1, wherein the flow regulator is further configured to, based on an increase of the flow rate of the fluid introduced through the device inlet, increase the number of deionization channels into which the fluid flows among the plurality of deionization channels.

3. The water treatment apparatus of claim 1, wherein the plurality of deionization channels comprises a first deionization channel and a second deionization channel having a deionization performance that is higher than a deionization performance of the first deionization channel.

4. The water treatment apparatus of claim 3, wherein the flow regulator is further configured to, based on an increase of the flow rate of the fluid introduced through the device inlet, sequentially open the first deionization channel and the second deionization channel.

5. The water treatment apparatus of claim 3, wherein a first ion storage capacity of a first electrode, among the plurality of electrodes, forming the second deionization channel is larger than a second ion storage capacity of a second electrode, among the plurality of electrodes, forming the first deionization channel.

6. The water treatment apparatus of claim 3, wherein a first gap of the first deionization channel is smaller than a second gap of the second deionization channel.

7. The water treatment apparatus of claim 1, wherein the flow regulator is further configured to regulate the number of deionization channels into which the fluid flows among the plurality of deionization channels, when the flow rate of the fluid introduced into the housing is a first flow rate, to be less than the number of deionization channels into which the fluid flows among the plurality of deionization channels, when the flow rate of the fluid introduced into the housing is a second flow rate that is greater than the first flow rate.

8. The water treatment apparatus of claim 1, wherein the plurality of deionization channels comprises a first deionization channel and a second deionization channel, and
wherein the plurality of electrodes comprises:
a first electrode;
an intermediate electrode spaced a first distance from the first electrode and forming the first deionization channel; and
a second electrode spaced a second distance from the intermediate electrode and forming the second deionization channel, the second distance being greater than the first distance.

9. The water treatment apparatus of claim 1, wherein the flow regulator comprises:
a regulation body configured to move based on the flow rate of the fluid introduced through the device inlet;
a moving body configured to move based on a movement of the regulation body; and
a pressing portion configured to move based on a movement of the moving body to open and close the plurality of deionization channels.

10. The water treatment apparatus of claim 9, wherein the plurality of electrodes comprises a current collector comprising a material that is compressible and restorable by the pressing portion.

11. The water treatment apparatus of claim 9, wherein the regulation body is further configured to move based on a difference between a first pressure of the fluid introduced through the device inlet and a second pressure of the fluid as discharged through the device outlet.

12. The water treatment apparatus of claim 11, wherein the regulation body is further configured to, based on the first pressure of the fluid introduced through the device inlet being higher than the second pressure of the fluid discharged through the device outlet, move to increase a size of a deionization channel into which the fluid flows or increase the number of deionization channels into which the fluid flows among the plurality of deionization channels.

13. The water treatment apparatus of claim 9, wherein the pressing portion is further configured to, according to the pressing portion opening at least a deionization channel of the plurality of deionization channels, move to regulate a size of an opening of the deionization channel.

14. The water treatment apparatus of claim 9, wherein the flow regulator comprises an elastic body configured to apply an elastic force to the moving body in a first direction in which the pressing portion opens the plurality of deionization channels, and
wherein the regulation body comprises a body support supporting the moving body in a second direction in which the pressing portion closes the plurality of deionization channels.

15. The water treatment apparatus of claim 9, further comprising:
a state display provided on the housing,
wherein the flow regulator comprises a slider configured to move relative to the housing according to the movement of the regulation body, the slider being positioned at a preset location with respect to the state display based on the flow rate of the fluid introduced through the device inlet.

16. A water treatment apparatus comprises:
a housing comprising a device inlet and a device outlet;
a first electrode;
a second electrode;
an intermediate electrode provided between the first electrode and the second electrode;
a first deionization channel formed between the first electrode and the intermediate electrode;
a second deionization channel formed between the second electrode and the intermediate electrode; and
a flow regulator configured to open and close the first deionization channel and the second deionization channel based on a flow rate of a fluid flowing into the housing.

17. The water treatment apparatus of claim 16, wherein the flow regulator is further configured to:
based on the flow rate of the fluid flowing into the housing being a first flow rate, open the first deionization channel to supply the fluid to the first deionization channel, and
based on the flow rate of the fluid flowing into the housing being a second flow rate which is greater than the first flow rate, open the first deionization channel and the second deionization channel to supply the fluid to the first deionization channel and the second deionization channel.

18. The water treatment apparatus of claim 17, wherein, while the first deionization channel and the second deionization channel open, a gap between the second electrode and the intermediate electrode is larger than a gap between the first electrode and the intermediate electrode.

19. The water treatment apparatus of claim 18, wherein the flow regulator is further configured to:
while the first deionization channel opens, regulate a size of the first deionization channel based on a pressure difference between the fluid received through the device inlet and the fluid discharged through the device outlet, and
while the second deionization channel opens, regulate a size of the second deionization channel based on a pressure difference between the fluid received through the device inlet and the fluid discharged through the device outlet.

20. The water treatment apparatus of claim 16, wherein a deionization performance of the second deionization channel is higher than a deionization performance of the first deionization channel, and
wherein the flow regulator is further configured to, based on an increase of the flow rate of the fluid received through the device inlet, sequentially open the first deionization channel and the second deionization channel.
